(19) United States
(12) Patent Application Publication
(10) Pub. No.: US 2006/0205890 A1
(43) Pub. Date: Sep. 14, 2006

(54) Polymer foam containing hydrogenated copolymer

(76) Inventors: Masahiro Sasagawa, Kanagawa-ken (JP); Toshinori Shiraki, Kanagawa-ken (JP); Chong-Sun Yoo, Busan (KR); Jung-Sik Yoon, Busan (KR); Kyung-Man Choi, Busan (KR); Gi-Yong Um, Busan (KR)

Correspondence Address: STAAS & HALSEY LLP, SUITE 700, 1201 NEW YORK AVENUE, N.W., WASHINGTON, DC, 20005, US

(21) Appl. No.: 10/549,618

(22) PCT Filed: Apr. 9, 2004
(86) PCT No.: PCT/JP04/05114

§ 371 Date: Sep. 20, 2005

(30) Foreign Application Priority Data
Apr. 10, 2003 (JP) 2003-106807
Jun. 6, 2003 (JP) 203-162253
Jun. 6, 2003 (JP) 203-162252

(51) Int. Cl. C08F 112/08; B32B 3/26; C08F 12/08; C08F 212/08

(52) U.S. Cl. 525/333.3; 428/304.4

(57) ABSTRACT

A polymer foam having a specific gravity of from 0.05 to 0.5 and comprising a plurality of cells defined by cell walls which constitute a polymer matrix, wherein the polymer matrix is comprised of 5 to 100 parts by weight of (A) a hydrogenated copolymer obtained by hydrogenating an unhydrogenated copolymer which contains at least one copolymer block S comprised of vinyl aromatic monomer units and conjugated diene monomer units, and 95 to 0 part by weight of (B) at least one polymer selected from the group consisting of an olefin polymer and a rubbery polymer, and wherein at least one peak of loss tangent (tanδ) is observed at −40° C. to lower than −10° C. in a dynamic viscoelastic spectrum obtained with respect to the hydrogenated copolymer (A).

### BACKGROUND OF THE INVENTION

1. Field of the Invention

The present invention relates to a polymer foam containing a hydrogenated copolymer. More particularly, the present invention is concerned with a polymer foam having a specific gravity of from 0.05 to 0.5 and comprising a plurality of cells defined by cell walls which constitute a polymer matrix, wherein the polymer matrix is comprised of 5 to 100 parts by weight of (A) a hydrogenated copolymer obtained by hydrogenating an unhydrogenated copolymer which comprises vinyl aromatic monomer units and conjugated diene monomer units and which contains at least one copolymer block S comprised of vinyl aromatic monomer units and conjugated diene monomer units, and 95 to 0 part by weight of (B) at least one polymer selected from the group consisting of an olefin polymer and a rubbery polymer, wherein the hydrogenated copolymer (A) has a content of the vinyl aromatic monomer units of from more than 40% by weight to 60% by weight, and wherein at least one peak of loss tangent (tanδ) is observed at −40° C. to lower than −10° C. in a dynamic viscoelastic spectrum obtained with respect to the hydrogenated copolymer (A). The polymer foam of the present invention has excellent properties with respect to flexibility, low temperature characteristics (such as flexibility at low temperatures), shock-absorbing property (low impact resilience), compression set resistance and the like, so that the polymer foam can be advantageously used as a shock absorber (especially a footwear material) and the like.

2. Prior Art

With respect to a block copolymer comprising vinyl aromatic monomer units and conjugated diene monomer units, when the vinyl aromatic monomer unit content thereof is relatively low, the block copolymer exhibits, even if not vulcanized, not only excellent elasticity at room temperature, which is comparable to that of a conventional, vulcanized natural or synthetic rubber, but also excellent processability at high temperatures, which is comparable to that of a conventional thermoplastic resin. Therefore, such a block copolymer having a relatively low content of vinyl aromatic monomer units is widely used in various fields, such as the fields of footwear, modifiers for plastics, modifiers for asphalts, and adhesive agents.

On the other hand, when the block copolymer comprising vinyl aromatic monomer units and conjugated diene monomer units has a relatively high content of vinyl aromatic monomer units, the block copolymer is a thermoplastic resin having excellent properties with respect to transparency and impact resistance. Therefore, such a block copolymer having a relatively high content of vinyl aromatic monomer units can be advantageously used in various fields, such as the fields of packaging containers for food, packaging materials for household goods, packaging materials for household electric appliances, packaging materials for industrial parts, and toys.

Further, a hydrogenation product of the above-mentioned block copolymer has excellent weathering resistance and excellent heat resistance, so that the hydrogenation product is advantageously used not only in the above-mentioned various fields, but also in the fields of automobile parts, medical equipment and the like.

However, the above-mentioned block copolymer is disadvantageous in the following points. When the block copolymer has a relatively low content of vinyl aromatic monomer units, although the block copolymer has excellent flexibility, the block copolymer has poor shock-absorbing property, thus rendering it difficult to broaden the range of use of such a block copolymer. On the other hand, when the block copolymer has a relatively high content of vinyl aromatic monomer units, the block copolymer has poor flexibility at room temperature and low temperatures and, hence, is unsuitable for use as a flexible material.

With respect to a copolymer comprising vinyl aromatic monomer units and conjugated diene monomer units, it has been attempted to develop a technology of improving the copolymer so as to exhibit excellent flexibility. For example, Unexamined Japanese Patent Application Laid-Open Specification No. Hei 2-158643 (corresponding to U.S. Pat. No. 5,109,069) discloses a composition comprising a hydrogenated copolymer and a polypropylene resin, wherein the hydrogenated copolymer is obtained by hydrogenating an unhydrogenated copolymer which comprises vinyl aromatic monomer units and conjugated diene monomer units and which has a vinyl aromatic monomer unit content of from 3 to 50% by weight, a molecular weight distribution of 10 or less (wherein the molecular weight distribution is defined as the ratio (Mw/Mn) of the weight average molecular weight (Mw) to the number average molecular weight (Mn)), and a vinyl bond content of from 10 to 90% as measured with respect to the conjugated diene monomer units in the unhydrogenated copolymer. However, this composition is still unsatisfactory with respect to shock-absorbing property though the composition is improved to some extent with respect to flexibility and low temperature characteristics.

Unexamined Japanese Patent Application Laid-Open Specification No. Hei 6-287365 discloses a composition comprising a hydrogenated copolymer and a polypropylene resin, wherein the hydrogenated copolymer is obtained by hydrogenating an unhydrogenated copolymer which comprises vinyl aromatic monomer units and conjugated diene monomer units and which has a vinyl aromatic monomer unit content of from 5 to 60% by weight and a vinyl bond content of 60% or more as measured with respect to the conjugated diene monomer units in the unhydrogenated copolymer. However, this composition is unsatisfactory with respect to flexibility and shock-absorbing property.

In recent years, it has been attempted to improve the above-mentioned block copolymer comprising vinyl aromatic monomer units and conjugated diene monomer units and having a relatively high content of vinyl aromatic monomer units, so as to exhibit excellent flexibility. For example, Unexamined Japanese Patent Application Laid-Open Specification No. Hei 2-300250 discloses a block copolymer comprising a homopolymer block of vinyl aromatic monomer units and a polymer block comprised of conjugated diene monomer units, wherein the conjugated diene polymer block comprises only isoprene monomer units or a mixture of isoprene monomer units and butadiene monomer units, and has a total content of 3,4-vinyl bonds and 1,2-vinyl bonds of 40% or more, and wherein, in a dynamic viscoelastic spectrum obtained with respect to the block copolymer, at least one peak of loss tangent (tanδ) is observed at 0° C. or more. However, the block copolymer is unsatisfactory with respect to flexibility and low temperature characteristics though the block copolymer has excellent shock-absorbing property.

WO98/12240 discloses a molding material comprised mainly of a hydrogenated block copolymer which is obtained by hydrogenating a block copolymer comprising a polymer block comprised mainly of styrene monomer units and a copolymer block comprised mainly of butadiene monomer units and styrene monomer units. However, the hydrogenated block copolymer described in this patent document has unsatisfactory flexibility and low temperature characteristics.

Thus, with respect to each of a copolymer comprising vinyl aromatic monomer units and conjugated diene monomer units, a hydrogenated copolymer obtained by hydrogenating such copolymer, a composition comprising such hydrogenated copolymer and a polymer other than the hydrogenated copolymer, a shaped article obtained from the above-mentioned copolymer, hydrogenated copolymer or composition, it is impossible to improve the copolymer, composition or shaped article, so as to exhibit excellent properties with respect to all of flexibility, low temperature characteristics and shock-absorbing property.

### SUMMARY OF THE INVENTION

In this situation, the present inventors have made extensive and intensive studies with a view toward developing a shaped article containing a hydrogenated copolymer, wherein the shaped article exhibits excellent properties with respect to all of flexibility, low temperature characteristics (such as flexibility at low temperatures) and shock-absorbing property. As a result, it has unexpectedly been found that such a shaped article is realized by a polymer foam having a specific gravity of from 0.05 to 0.5 and comprising a plurality of cells defined by cell walls which constitute a polymer matrix, wherein the polymer matrix is comprised of 5 to 100 parts by weight of (A) a hydrogenated copolymer obtained by hydrogenating an unhydrogenated copolymer which comprises vinyl aromatic monomer units and conjugated diene monomer units and which contains at least one copolymer block S comprised of vinyl aromatic monomer units and conjugated diene monomer units, and 95 to 0 part by weight of (B) at least one polymer selected from the group consisting of an olefin polymer and a rubbery polymer, wherein the hydrogenated copolymer (A) has a content of the vinyl aromatic monomer units of from more than 40% by weight to 60% by weight, and wherein at least one peak of loss tangent (tans) is observed at −40° C. to lower than −10° C. in a dynamic viscoelastic spectrum obtained with respect to the hydrogenated copolymer (A). The present inventors have also found that the polymer foam also has excellent compression set resistance and the like. Based on this finding, the present invention has been completed.

Accordingly, it is an object of the present invention to provide a polymer foam which exhibits excellent properties with respect to all of flexibility, low temperature characteristics (such as flexibility at low temperatures), shock-absorbing property (low impact resilience), compression set resistance and the like.

The foregoing and other objects, features and advantages of the present invention will be apparent from the following detailed description and appended claims.

### DETAILED DESCRIPTION OF THE INVENTION

According to the present invention, there is provided a polymer foam comprising a plurality of cells defined by cell walls which constitute a polymer matrix,

the polymer matrix being comprised of:

5 to 100 parts by weight, relative to 100 parts by weight of the total of components (A) and (B), of (A) a hydrogenated copolymer obtained by hydrogenating an unhydrogenated copolymer comprising vinyl aromatic monomer units and conjugated diene monomer units, the unhydrogenated copolymer containing at least one copolymer block S comprised of vinyl aromatic monomer units and conjugated diene monomer units, and

95 to 0 part by weight, relative to 100 parts by weight of the total of components (A) and (B), of (B) at least one polymer selected from the group consisting of an olefin polymer other than the hydrogenated copolymer (A) and a rubbery polymer other than the hydrogenated copolymer (A),

the hydrogenated copolymer (A) having the following characteristics (1) and (2):

(1) the hydrogenated copolymer (A) has a content of the vinyl aromatic monomer units of from more than 40% by weight to 60% by weight, based on the weight of the hydrogenated copolymer (A), and

(2) at least one peak of loss tangent (tanδ) is observed at −40° C. to lower than −10° C. in a dynamic viscoelastic spectrum obtained with respect to the hydrogenated copolymer (A),

the polymer foam having a specific gravity of from 0.05 to 0.5.

For easy understanding of the present invention, the essential features and various preferred embodiments of the present invention are enumerated below.

1. A polymer foam comprising a plurality of cells defined by cell walls which constitute a polymer matrix,

the polymer matrix being comprised of:

5 to 100 parts by weight, relative to 100 parts by weight of the total of components (A) and (B), of (A) a hydrogenated copolymer obtained by hydrogenating an unhydrogenated copolymer comprising vinyl aromatic monomer units and conjugated diene monomer units, the unhydrogenated copolymer containing at least one copolymer block S comprised of vinyl aromatic monomer units and conjugated diene monomer units, and

95 to 0 part by weight, relative to 100 parts by weight of the total of components (A) and (B), of (B) at least one polymer selected from the group consisting of an olefin polymer other than the hydrogenated copolymer (A) and a rubbery polymer other than the hydrogenated copolymer (A),

the hydrogenated copolymer (A) having the following characteristics (1) and (2):

(1) the hydrogenated copolymer (A) has a content of the vinyl aromatic monomer units of from more than 40% by weight to 60% by weight, based on the weight of the hydrogenated copolymer (A), and

(2) at least one peak of loss tangent (tanδ) is observed at −40° C. to lower than −10° C. in a dynamic viscoelastic spectrum obtained with respect to the hydrogenated copolymer (A),

the polymer foam having a specific gravity of from 0.05 to 0.5.

2. The polymer foam according to item 1 above, wherein the amounts of the hydrogenated copolymer (A) and the polymer (B) are, respectively, 5 to 95 parts by weight and 95 to 5 parts by weight, relative to 100 parts by weight of the total of components (A) and (B).

3. The polymer foam according to item 1 or 2 above, wherein substantially no crystallization peak ascribed to at least one hydrogenated copolymer block obtained by hydrogenating the at least one copolymer block S is observed at −50 to 100° C. in a differential scanning calorimetry (DSC) chart obtained with respect to the hydrogenated copolymer (A).

4. The polymer foam according to any one of items 1 to 3 above, wherein at least one of the at least one copolymer block S in the unhydrogenated copolymer has a structure wherein the vinyl aromatic monomer units are distributed in a tapered configuration.

5. The polymer foam according to any one of items 1 to 4 above, wherein the unhydrogenated copolymer further contains a homopolymer block H of vinyl aromatic monomer units, the amount of the homopolymer block H in the unhydrogenated copolymer being in the range of from 1 to 40% by weight, based on the weight of the unhydrogenated copolymer.

6. The polymer foam according to any one of items 1 to 3 above, wherein the unhydrogenated copolymer is at least one polymer selected from the group consisting of copolymers which are, respectively, represented by the following formulae:
S, (1)
S—H, (2)
S—H—S, (3)
(S—H)ₘ—X, (4)
(S—H)ₙ—X—(H)ₚ, (5)
H—S—H, (6)
S-E, (7)
H—S-E, (8)
E-S—H—S, (9)
(E-S—H)ₘ—X and (10)
(E-S-E)ₘ—X, (11)
wherein each S independently represents a copolymer block comprised of vinyl aromatic monomer units and conjugated diene monomer units, each H independently represents a homopolymer block of vinyl aromatic monomer units, each E independently represents a homopolymer block of conjugated diene monomer units, each X independently represents a residue of a coupling agent, each m independently represents an integer of 2 or more, and each of n and p independently represents an integer of 1 or more.
   7. The polymer foam according to any one of items 1 to 6 above, wherein the hydrogenated copolymer (A) has bonded thereto a modifier having a functional group.
   8. The polymer foam according to item 7 above, wherein the modifier is a first-order modifier having at least one functional group selected from the group consisting of a hydroxyl group, an epoxy group, an amino group, a silanol group and an alkoxysilane group.
   9. The polymer foam according to item 7 above, wherein the modifier comprises a first-order modifier and, bonded thereto, a second-order modifier,

wherein the first-order modifier has at least one functional group selected from the group consisting of a hydroxyl group, an epoxy group, an amino group, a silanol group and an alkoxysilane group, and

wherein the second-order modifier has at least one functional group selected from the group consisting of a hydroxyl group, a carboxyl group, an acid anhydride group, an isocyanate group, an epoxy group and an alkoxysilane group.

10. The polymer foam according to any one of items 1 to 9 above, wherein the olefin polymer as component (B) is at least one ethylene polymer selected from the group consisting of a polyethylene, an ethylene/propylene copolymer, an ethylene/propylene/butylene copolymer, an ethylene/butylene copolymer, an ethylene/hexene copolymer, an ethylene/octene copolymer, an ethylene/vinyl acetate copolymer, an ethylene/acrylic ester copolymer and an ethylene/methacrylic ester copolymer.

11. The polymer foam according to any one of items 1 to 9 above, wherein the rubbery polymer as component (B) is at least one member selected from the group consisting of a 1,2-polybutadiene, a hydrogenation product of a conjugated diene homopolymer, a copolymer comprised of vinyl aromatic monomer units and conjugated diene monomer units and a hydrogenation product thereof, a block copolymer comprised of a homopolymer block of vinyl aromatic monomer units and at least one polymer block selected from the group consisting of a homopolymer block of conjugated diene monomer units and a copolymer block comprised of vinyl aromatic monomer units and conjugated diene monomer units and a hydrogenation product thereof, an acrylonitrile/butadiene rubber and a hydrogenation product thereof, an ethylene/propylene/diene rubber (EPDM), a butyl rubber and a natural rubber.

12. The polymer foam according to item 11 above, wherein the rubbery polymer as component (B) is at least one member selected from the group consisting of a hydrogenation product of a copolymer comprised of vinyl aromatic monomer units and conjugated diene monomer units, the hydrogenation product having a vinyl aromatic monomer unit content of from more than 60% by weight to 90% by weight, based on the weight of the hydrogenation product; and a block copolymer comprised of a homopolymer block of vinyl aromatic monomer units and at least one polymer block selected from the group consisting of a homopolymer block of conjugated diene monomer units and a copolymer block comprised of vinyl aromatic monomer units and conjugated diene monomer units and a hydrogenation product thereof.

13. The polymer foam according to any one of items 1 to 12 above, which exhibits an impact resilience of 40% or less.

14. The polymer foam according to any one of items 1 to 13 above, which has a specific gravity of from 0.1 to 0.3.

15. The polymer foam according to any one of items 1 to 14 above, which is a shock absorber.

Hereinbelow, the present invention is described in detail.

In the present invention, the monomer units of the polymer are named in accordance with a nomenclature wherein the names of the original monomers from which the monomer units are derived are used with the term “monomer unit” attached thereto. For example, the term “vinyl aromatic monomer unit” means a monomer unit which is formed in a polymer obtained by the polymerization of the vinyl aromatic monomer. The vinyl aromatic monomer unit has a molecular structure wherein the two carbon atoms of a substituted ethylene group derived from a substituted vinyl group respectively form linkages to adjacent vinyl aromatic monomer units. Similarly, the term “conjugated diene monomer unit” means a monomer unit which is formed in a polymer obtained by the polymerization of the conjugated diene monomer. The conjugated diene monomer unit has a molecular structure wherein the two carbon atoms of an olefin corresponding to the conjugated diene monomer respectively form linkages to adjacent conjugated diene monomer units.

The polymer foam of the present invention comprises a plurality of cells defined by cell walls which constitute a polymer matrix. With respect to the structure of the cells, there is no particular limitation. For example, all of the cells may be open cells. Alternatively, all of the cells may be closed cells. Further, the polymer foam may contain open cells and closed cells in combination. That is, the polymer foam of the present invention may have an open cell cellular structure, or a closed cell cellular structure, or may have both an open cell cellular structure and a closed cell cellular structure.

The polymer matrix is comprised of: 5 to 100 parts by weight, relative to 100 parts by weight of the total of components (A) and (B), of (A) a hydrogenated copolymer; and 95 to 0 part by weight, relative to 100 parts by weight of the total of components (A) and (B), of (B) at least one polymer selected from the group consisting of an olefin polymer other than the hydrogenated copolymer (A) and a rubbery polymer other than the hydrogenated copolymer (A).

The hydrogenated copolymer (A) is obtained by hydrogenating an unhydrogenated copolymer comprising vinyl aromatic monomer units and conjugated diene monomer units. The unhydrogenated copolymer contains at least one copolymer block S comprised of vinyl aromatic monomer units and conjugated diene monomer units. (Hereinafter, the unhydrogenated copolymer is frequently referred to as “base unhydrogenated copolymer”.)

The hydrogenated copolymer (A) has the following characteristics (1) and (2):

(1) the hydrogenated copolymer (A) has a content of the vinyl aromatic monomer units of from more than 40% by weight to 60% by weight, based on the weight of the hydrogenated copolymer (A), and

(2) at least one peak of loss tangent (tanδ) is observed at −40° C. to lower than −10° C. in a dynamic viscoelastic spectrum obtained with respect to the hydrogenated copolymer (A).

With respect to the above-mentioned characteristic (1), explanation is given below. The content of the vinyl aromatic monomer units in the hydrogenated copolymer (A) is from more than 40% by weight to 60% by weight, based on the weight of the hydrogenated copolymer (A). From the viewpoint of flexibility and shock-absorbing property, the content of the vinyl aromatic monomer units in the hydrogenated copolymer (A) is preferably from 43 to 57% by weight, more preferably from 45 to 55% by weight.

The content of the vinyl aromatic monomer units in the hydrogenated copolymer (A) is approximately equal to the content of the vinyl aromatic monomer units in the base unhydrogenated copolymer. Therefore, the content of the vinyl aromatic monomer units in the base unhydrogenated copolymer is used as the content of the vinyl aromatic monomer units in the hydrogenated copolymer (A). The content of the vinyl aromatic monomer units in the base unhydrogenated copolymer is measured by means of an ultraviolet spectrophotometer.

With respect to the above-mentioned characteristic (2), explanation is given below. In a dynamic viscoelastic spectrum obtained with respect to the hydrogenated copolymer (A), at least one peak of loss tangent (tanδ) is observed at −40° C. to lower than −10° C., preferably at −35 to −12° C., more preferably at −30 to −14° C. In the dynamic viscoelastic spectrum, a peak of loss tangent which is observed at −40° C. to lower than −10° C. is ascribed to a hydrogenated copolymer block which is obtained by hydrogenating a copolymer block (in the base unhydrogenated copolymer) comprised of vinyl aromatic monomer units and conjugated diene monomer units. The presence of at least one peak of loss tangent in the range of from −40° C. to lower than −10° C. is essential for achieving a good balance of flexibility, low temperature characteristics and shock-absorbing property (low impact resilience) in the polymer foam.

The measurement of a peak of loss tangent (tans) in a dynamic viscoelastic spectrum is done at a frequency of 10 Hz by means of a dynamic viscoelastic spectrum analyzer.

As mentioned above, the base unhydrogenated copolymer contains at least one copolymer block S comprised of vinyl aromatic monomer units and conjugated diene monomer units. With respect to the conjugated diene monomer unit/vinyl aromatic monomer unit weight ratio in the copolymer block S, there is no particular limitation. However, when the above-mentioned fact that at least one peak of loss tangent is required to be present in the range of from −40° C. to lower than −10° C. is taken into consideration, the conjugated diene monomer unit/vinyl aromatic monomer unit weight ratio in the copolymer block S is preferably from 50/50 to 90/10, more preferably from 53/47 to 80/20, still more preferably from 56/44 to 75/25.

In the present invention, it is preferred that substantially no crystallization peak ascribed to the at least one hydrogenated copolymer block obtained by hydrogenating the at least one copolymer block S is observed at −50 to 100° C. in a differential scanning calorimetry (DSC) chart obtained with respect to the hydrogenated copolymer (A). In the present invention, the expression “substantially no crystallization peak ascribed to the at least one hydrogenated copolymer block obtained by hydrogenating the at least one copolymer block S is observed at −50 to 100° C. in a differential scanning calorimetry (DSC) chart obtained with respect to the hydrogenated copolymer (A)” means that no peak indicating the occurrence of crystallization (i.e., crystallization peak) is observed within the above-mentioned temperature range, or that a crystallization peak is observed within the above-mentioned temperature range, but the quantity of heat at the crystallization peak is less than 3 J/g, preferably less than 2 J/g, more preferably less than 1 J/g, still more preferably zero.

With respect to the distribution of the vinyl aromatic monomer units in the copolymer block S, there is no particular limitation. For example, the vinyl aromatic monomer units may be uniformly distributed or may be distributed in a tapered configuration. Further, the copolymer block S may have a plurality of segments in which the vinyl aromatic monomer units are uniformly distributed, and/or may have a plurality of segments in which the vinyl aromatic monomer units are distributed in a tapered configuration. Furthermore, the copolymer block S may have a plurality of segments having different vinyl aromatic monomer unit contents. In the present invention, the expression “the vinyl aromatic monomer units are distributed in a tapered configuration” means that the content of the vinyl aromatic monomer units is increased or decreased along the length of the chain of the copolymer block S.

It is preferred that the base unhydrogenated copolymer contains a homopolymer block H of vinyl aromatic monomer units. From the viewpoint of flexibility and shock-absorbing property, the amount of the homopolymer block H in the base unhydrogenated copolymer is preferably 40% by weight or less, based on the weight of the base unhydrogenated copolymer. The amount of the homopolymer block H in the base unhydrogenated copolymer is more preferably from 1 to 40% by weight, still more preferably from 5 to 35% by weight, still more preferably from 10 to 30% by weight, still more preferably from 13 to 25% by weight, based on the weight of the base unhydrogenated copolymer.

The content of the homopolymer block of vinyl aromatic monomer units in the base unhydrogenated copolymer (hereinafter, this homopolymer block is frequently referred to as “vinyl aromatic polymer block”) can be measured by the following method. The weight of a vinyl aromatic polymer block component is obtained by a method in which the base unhydrogenated copolymer is subjected to oxidative degradation in the presence of osmium tetraoxide as a catalyst using tert-butyl hydroperoxide (i.e., the method described in I. M. KOLTHOFF et al., J. Polym. Sci. vol. 1, p. 429 (1946)) (hereinafter frequently referred to as “osmium tetraoxide degradation method”). Using the obtained weight of the vinyl aromatic polymer block component, the content of the vinyl aromatic polymer block in the base unhydrogenated copolymer is calculated by the below-mentioned formula, with the proviso that, among the polymer chains (formed by the oxidative degradation) corresponding to vinyl aromatic polymer blocks, the polymer chains having a polymerization degree of about 30 or less are not taken into consideration in the measurement of the content of the vinyl aromatic polymer block.
Content of the vinyl aromatic polymer block (% by weight)={(weight of the vinyl aromatic polymer block component in the base unhydrogenated copolymer)/(weight of the base unhydrogenated copolymer)}×100.

Also, the content of the vinyl aromatic polymer block can be obtained by a method in which the hydrogenated copolymer (A) is directly analyzed by means of a nuclear magnetic resonance (NMR) apparatus (see Y. Tanaka et al., “RUBBER CHEMISTRY and TECHNOLOGY, vol. 54, p. 685 (1981)) (hereinafter, this method is frequently referred to as “NMR method”).

There is a correlation between the value of the content of the vinyl aromatic polymer block obtained by the osmium tetraoxide degradation method (hereinafter, this value is referred to as “Os value”) and the value of the content of the vinyl aromatic polymer block obtained by the NMR method (hereinafter, this value is frequently referred to as “Ns value”). More specifically, as a result of the studies by the present inventors made with respect to various copolymers having different contents of the vinyl aromatic polymer block, it has been found that the above-mentioned correlation is represented by the following formula:
Os value=−0.012(Ns value) ²+1.8(Ns value)−13.0

In the present invention, when the Ns value is obtained by the NMR method, the obtained Ns value is converted into the Os value, utilizing the above-mentioned formula representing the correlationship between the Os value and the Ns value.

With respect to the configuration of the base unhydrogenated copolymer, there is no particular limitation, so long as the base unhydrogenated copolymer comprises vinyl aromatic monomer units and conjugated diene monomer units and contains at least one copolymer block S comprised of vinyl aromatic monomer units and conjugated diene monomer units and so long as the hydrogenated copolymer (A) obtained by hydrogenating the base unhydrogenated copolymer has the above-mentioned characteristics (1) and (2). Examples of base unhydrogenated copolymers include copolymers having block configurations represented by the following formulae:
S,
(H—S)ₙ,
H— (S—H)ₙ,
S—(H—S)ₙ,
[(S—H)ₙ]ₘ—X,
[(H—S)ₙ]ₘ—X,
[(S—H)ₙ—S]ₘ—X,
[(H—S)ₙ—H]ₘ—X,
(S—H)ₙ—X—(H)_{p,}
(E—S)ₙ,
E—(S-E)ₙ,
S-(E—S)ₙ,
[(E—S)ₙ]ₘ—X,
[(S-E)ₙ-E]ₘ—X,
E—(S—H)ₙ,
E—(H—S)ₙ,
E—(H—S—H)ₙ,
E—(S—H—S)ₙ,
H-E—(S—H)ₙ,
H-E—(H—S)ₙ,
H-E—(S—H)ₙ—S,
[(H—S-E)ₙ]ₘ—X,
[H—(S-E)ₙ]ₘ—X,
[(H—S)ₙ-E]ₘ—X,
[(H—S—H)ₙ-E]ₘ—X,
[(S—H—S)ₙ-E]ₘ—X,
[(E—S—H)ₙ]ₘ—X,
[E—(S—H)ₙ]ₘ—X,
[E—(H—S—H)ₙ]ₘ—X and
[E—(S—H—S)ₙ]ₘ—X,
wherein each S independently represents a copolymer block comprised of vinyl aromatic monomer units and conjugated diene monomer units, each H independently represents a homopolymer block of vinyl aromatic monomer units, each E independently represents a homopolymer block of conjugated diene monomer units, each X independently represents a residue of a coupling agent or a residue of a multifunctional polymerization initiator, each m independently represents an integer of 2 or more, preferably an integer of from 2 to 10, and each of n and p independently represents an integer of 1 or more, preferably an integer of from 1 to 10.

Examples of residues of coupling agents include residues of the below-mentioned coupling agents. Examples of residues of multifunctional polymerization initiators include a residue of a reaction product of diisopropenylbenzene and sec-butyllithium, and a residue of a reaction product obtained by reacting divinylbenzene, sec-butyllithium and a small amount of 1,3-butadiene.

Among the above-mentioned unhydrogenated copolymers, preferred is at least one unhydrogenated copolymer selected from the group consisting of copolymers which are, respectively, represented by the following formulae:
S, (1)
S—H, (2)
S—H—S, (3)
(S—H)ₘ—X, (4)
(S—H)ₙ—X—(H)ₚ, (5)
H—S—H, (6)
S-E, (7)
H—S-E, (8)
E-S—H—S, (9)
(E-S—H)ₘ—X and (10)
(E-S-E)ₘ—X, (11)
wherein S, H, E, X, m, n and p are as defined above.

With respect to the weight average molecular weight of the hydrogenated copolymer (A), there is no particular limitation. However, from the viewpoint of the mechanical strength (such as tensile strength) and compression set resistance of the polymer foam, the weight average molecular weight of the hydrogenated copolymer (A) is preferably 60,000 or more. Further, from the viewpoint of the processability of the polymer foam, the weight average molecular weight of the hydrogenated copolymer (A) is preferably 1,000,000 or less. The weight average molecular weight of the hydrogenated copolymer (A) is more preferably from more than 100,000 to 800,000, still more preferably from 130,000 to 500,000. With respect to the molecular weight distribution of the hydrogenated copolymer (A), the molecular weight distribution is preferably from 1.05 to 6. From the viewpoint of the processability of the polymer foam, the molecular weight distribution of the hydrogenated copolymer (A) is more preferably from 1.1 to 6, still more preferably from 1.2 to 5, still more preferably from 1.4 to 4.5.

The weight average molecular weight of the hydrogenated copolymer is approximately equal to that of the base unhydrogenated copolymer. Therefore, the weight average molecular weight of the base unhydrogenated copolymer is used as the weight average molecular weight of the hydrogenated copolymer. The weight average molecular weight of the base unhydrogenated copolymer is measured by gel permeation chromatography (GPC) using a calibration curve obtained with respect to commercially available standard monodisperse polystyrenes having predetermined molecular weights. The number average molecular weight of the hydrogenated copolymer can be obtained in the same manner as in the case of the weight average molecular weight of the hydrogenated copolymer. The molecular weight distribution of the hydrogenated copolymer is obtained, by calculation, as the ratio (Mw/Mn) of the weight average molecular weight (Mw) of the hydrogenated copolymer to the number average molecular weight (Mn) of the hydrogenated copolymer.

With respect to the hydrogenation ratio of the hydrogenated copolymer (A) as measured with respect to the conjugated diene monomer units, there is no particular limitation. However, from the viewpoint of the mechanical strength and compression set resistance of the polymer foam, the hydrogenation ratio of the hydrogenated copolymer (A) as measured with respect to the conjugated diene monomer units is generally from 70% or more, preferably from 80% or more, more preferably from 85% or more, still more preferably from 90% or more. The above-mentioned hydrogenation ratio is measured by means of a nuclear magnetic resonance (NMR) apparatus.

With respect to the microstructure (i.e., the contents of a cis bond, a trans bond, and a vinyl bond) of the conjugated diene monomer units in the base unhydrogenated copolymer can be appropriately controlled by using the below-described polar compound and the like.

With respect to the vinyl bond content of the conjugated diene monomer units of the copolymer block comprised of vinyl aromatic monomer units and conjugated diene monomer units in the base unhydrogenated copolymer, there is no particular limitation; however, it is preferred that the vinyl bond content is from 5% to less than 40% (hereinafter, the vinyl bond content means the total content of the 1,2-vinyl bond and 3,4-vinyl bond with the proviso that, when only 1,3-butadiene is used as the conjugated diene monomer, the vinyl bond content means the content of the 1,2-vinyl bond). From the viewpoint of the low impact resilience and handling property (anti-blocking property) of the polymer foam, the vinyl bond content is more preferably from 5 to 35%, still more preferably from 8 to 30%, still more preferably from 10 to 25%. Herein, the “anti-blocking property” means a resistance to adhesion phenomena (which are generally referred to as “blocking”) wherein when, for example, stacked resin shaped articles or a rolled resin film (which have or has resin surfaces which are in contact with each other) are or is stored for a long period of time, strong adhesion disadvantageously occurs between the resin surfaces, so that it becomes difficult to separate the resin surfaces from each other. The vinyl bond content is measured by means of an infrared spectrophotometer.

In the present invention, the conjugated diene monomer is a diolefin having a pair of conjugated double bonds. Examples of conjugated diene monomers used in the base unhydrogenated copolymer include 1,3-butadiene, 2-methyl-1,3-butadiene (i.e., isoprene), 2,3-dimethyl-1,3-butadiene, 1,3-pentadiene, 2-methyl-1,3-pentadiene and 1,3-hexadiene. Of these conjugated diene monomers, preferred are 1,3-butadiene and isoprene. These conjugated diene monomers can be used individually or in combination.

Examples of vinyl aromatic monomers used in the base unhydrogenated copolymer include styrene, α-methylstyrene, p-methylstyrene, divinylbenzene, 1,1-diphenylethylene, N,N-dimethyl-p-aminoethylstyrene and N,N-diethyl-p-aminoethylstyrene. Of these vinyl aromatic monomers, styrene is preferred. These vinyl aromatic monomers can be used individually or in combination.

With respect to the method for producing the base unhydrogenated copolymer, explanation is given below. With respect to the method for producing the base unhydrogenated copolymer, there is no particular limitation, and any conventional method can be employed. For example, the base unhydrogenated copolymer can be produced by a living anionic polymerization performed in a hydrocarbon solvent in the presence of a polymerization initiator, such as an organic alkali metal compound.

Examples of hydrocarbon solvents include aliphatic hydrocarbons, such as n-butane, isobutane, n-pentane, n-hexane, n-heptane and n-octane; alicyclic hydrocarbons, such as cyclopentane, cyclohexane, cycloheptane and methylcycloheptane; and aromatic hydrocarbons, such as benzene, toluene, xylene and ethylbenzene.

Examples of polymerization initiators include aliphatic hydrocarbon-alkali metal compounds, aromatic hydrocarbon-alkali metal compounds, and organic amino-alkali metal compounds, which have a living anionic polymerization activity with respect to a conjugated diene monomer and a vinyl aromatic monomer. Specific examples of polymerization initiators include n-propyl-lithium, n-butyllithium, sec-butyllithium, tert-butyllithium, a reaction product of diisopropenylbenzene and sec-butyllithium, and a reaction product obtained by reacting divinylbenzene, sec-butyllithium and a small amount of 1,3-butadiene. Further examples of polymerization initiators include the organic alkali metal compounds described in U.S. Pat. No. 5,708,092, GB Patent No. 2,241,239 and U.S. Pat. No. 5,527,753.

In the present invention, when the copolymerization of a conjugated diene monomer and a vinyl aromatic monomer is performed in the presence of an organic alkali metal compound as a polymerization initiator, there may used a tertiary amine or an ether compound as a vinyl bond-forming agent, which is used for increasing the amount of vinyl bonds (i.e., a 1,2-vinyl bond and a 3,4-vinyl bond) formed by the conjugated diene monomer.

Examples of tertiary amines include a compound represented by the formula: R¹R²R³N, wherein each of R¹, R² and R³ independently represents a C₁-C₂₀ hydrocarbon group or a C₁-C₂₀ hydrocarbon group substituted with a tertiary amino group. Specific examples of tertiary amines include trimethylamine, triethylamine, tributylamine, N,N-dimethylaniline, N-ethylpiperidine, N-methylpyrrolidine, N,N,N′,N′-tetramethylethylenediamine, N,N,N′,N′-tetraethylethylenediamine, 1,2-dipiperidinoethane, trimethylaminoethylpiperazine, N,N,N′,N″,N″-pentamethylethylenetriamine and N,N′-dioctyl-p-phenylenediamine.

Examples of ether compounds include a linear ether compound and a cyclic ether compound. Examples of linear ether compounds include dimethyl ether; diethyl ether; diphenyl ether; ethylene glycol dialkyl ethers, such as ethylene glycol dimethyl ether, ethylene glycol diethyl ether and ethylene glycol dibutyl ether; and diethylene glycol dialkyl ethers, such as diethylene glycol dimethyl ether, diethylene glycol diethyl ether and diethylene glycol dibutyl ether. Examples of cyclic ether compounds include tetrahydrofuran, dioxane, 2,5-dimethyloxolane, 2,2,5,5-tetramethyloxolane, 2,2-bis(2-oxolanyl)propane and an alkyl ether of furfuryl alcohol.

In the present invention, the copolymerization for producing the base unhydrogenated copolymer in the presence of an organic alkali metal compound as a polymerization initiator can be performed either in a batchwise manner or in a continuous manner. Further, the copolymerization may be performed in a manner wherein a batchwise operation and a continuous operation are used in combination. The reaction temperature for the copolymerization is generally in the range of from 0 to 180° C., preferably from 30 to 150° C. The reaction time for the copolymerization varies depending on other conditions, but is generally within 48 hours, preferably in the range of from 0.1 to 10 hours. It is preferred that the atmosphere of the copolymerization reaction system is of an inert gas, such as nitrogen gas. With respect to the pressure for the copolymerization reaction, there is no particular limitation so long as the pressure is sufficient for the monomers and the solvent to maintain a liquid state at a reaction temperature in the above-mentioned range. Further, a care must be taken so as to prevent the intrusion of impurities (such as water, oxygen and carbon dioxide), which deactivate the catalyst and the living polymer, into the copolymerization reaction system.

After completion of the copolymerization reaction, a coupling agent having a functionality of two or more may be added to the copolymerization reaction system to perform a coupling reaction. With respect to the coupling agent having a functionality of two or more, there is no particular limitation, and any of the conventional coupling agents can be used. Examples of bifunctional coupling agents include dihalides, such as dimethyldichlorosilane and dimethyldibromosilane; and acid esters, such as methyl benzoate, ethyl benzoate, phenyl benzoate and a phthalic ester. Examples of coupling agents having a functionality of three or more include polyhydric alcohols having three or more hydroxyl groups; multivalent epoxy compounds, such as epoxydized soy bean oil and diglycidyl bisphenol A; polyhalogenated compounds, such as a halogenated silicon compound represented by the formula: R₄₋ₙSiXₙ, wherein each R independently represents a C₁-C₂₀ hydrocarbon group, each X independently represents a halogen atom, and n is 3 or 4; and a halogenated tin compound represented by the formula: R₄₋ₙSnXₙ, wherein each R independently represents a C₁-C₂₀ hydrocarbon group, each X independently represents a halogen atom, and n is 3 or 4. Specific examples of halogenated silicon compounds include methylsilyl trichloride, t-butylsilyl trichloride, silicon tetrachloride and bromination products thereof. Specific examples of halogenated tin compounds include methyltin trichloride, t-butyltin trichloride and tin tetrachloride. Further, dimethyl carbonate, diethyl carbonate or the like can be used as a multifunctional coupling agent.

By hydrogenating the thus-produced unhydrogenated copolymer in the presence of a hydrogenation catalyst, the hydrogenated copolymer (A) can be produced. With respect to the hydrogenation catalyst, there is no particular limitation, and any of the conventional hydrogenation catalysts can be used. Examples of hydrogenation catalysts include:

(1) a carried, heterogeneous hydrogenation catalyst comprising a carrier (such as carbon, silica, alumina or diatomaceous earth) having carried thereon a metal, such as Ni, Pt, Pd or Ru;

(2) the so-called Ziegler type hydrogenation catalyst which uses a transition metal salt (such as an organic acid salt or acetylacetone salt of a metal, such as Ni, Co, Fe or Cr) in combination with a reducing agent, such as an organoaluminum compound; and

(3) a homogeneous hydrogenation catalyst, such as the so-called organometal complex, e.g., an organometal compound containing a metal, such as Ti, Ru, Rh or Zr.

Specific examples of hydrogenation catalysts include those which are described in Examined Japanese Patent Application Publication Nos. Sho 63-4841, Hei 1-53851 and Hei 2-9041. As preferred examples of hydrogenation catalysts, there can be mentioned a titanocene compound and a mixture of a titanocene compound and a reductive organometal compound.

Examples of titanocene compounds include those which are described in Unexamined Japanese Patent Application Laid-Open Specification No. Hei 8-109219. As specific examples of titanocene compounds, there can be mentioned compounds (e.g., biscyclopentadienyltitanium dichloride and monopentamethylcyclopentadienyltitanium trichloride) which have at least one ligand having a (substituted) cyclopentadienyl skeleton, an indenyl skeleton or a fluorenyl skeleton. Examples of reductive organometal compounds include organic alkali metal compounds, such as an organolithium compound; an organomagnesium compound; an organoaluminum compound; an organoboron compound; and an organozinc compound.

The hydrogenation reaction for producing the hydrogenated copolymer is performed generally at 0 to 200° C., preferably at 30 to 150° C. The hydrogen pressure in the hydrogenation reaction is generally in the range of from 0.1 to 15 MPa, preferably from 0.2 to 10 MPa, more preferably from 0.3 to 5 MPa. The hydrogenation reaction time is generally in the range of from 3 minutes to 10 hours, preferably from 10 minutes to 5 hours. The hydrogenation reaction may be performed either in a batchwise manner or in a continuous manner. Further, the hydrogenation reaction may be performed in a manner wherein a batchwise operation and a continuous operation are used in combination.

By the method described hereinabove, the hydrogenated copolymer is obtained in the form of a solution thereof in a solvent. From the obtained solution, the hydrogenated copolymer is separated. If desired, before the separation of the hydrogenated copolymer, a catalyst residue may be separated from the solution. Examples of methods for separating the hydrogenated copolymer and the solvent to recover the hydrogenated copolymer include a method in which a polar solvent (which is a poor solvent for the hydrogenated copolymer), such as acetone or an alcohol, is added to the solution containing the hydrogenated copolymer, thereby precipitating the hydrogenated copolymer, followed by recovery of the precipitated hydrogenated copolymer; a method in which the solution containing the hydrogenated copolymer is added to hot water while stirring, followed by removal of the solvent by steam stripping to recover the hydrogenated copolymer; and a method in which the solution containing the hydrogenated copolymer is directly heated to distill off the solvent.

The hydrogenated copolymer (A) may have incorporated therein a stabilizer. Examples of stabilizers include phenol type stabilizers, phosphorus type stabilizers, sulfur type stabilizers and amine type stabilizers.

The hydrogenated copolymer (A) may have bonded thereto a modifier having a functional group (hereinafter, such a hydrogenated copolymer (A) is frequently referred to as “modified hydrogenated copolymer (A)”).

As a modifier having a functional group, there can be mentioned a first-order modifier having at least one functional group selected from the group consisting of a hydroxyl group, a carboxyl group, a carbonyl group, a thiocarbonyl group, an acid halide group, an acid anhydride group, a carboxylic acid group, a thiocarboxyl group, an aldehyde group, a thioaldehyde group, a carboxylic ester group, an amide group, a sulfonic acid group, a sulfonic ester group, a phosphoric acid group, a phosphoric ester group, an amino group, an imino group, a nitrile group, a pyridyl group, a quinoline group, an epoxy group, a thioepoxy group, a sulfide group, an isocyanate group, an isothiocyanate group, a silicon halide group, a silanol group, an alkoxysilane group (which preferably has 1 to 24 carbon atoms), a tin halide group, an alkoxytin group and a phenyltin group. Of the above-mentioned functional groups, preferred are a hydroxyl group, an epoxy group, an amino group, a silanol group and an alkoxysilane group (which preferably has 1 to 24 carbon atoms). (Hereinafter, a hydrogenated copolymer (A) which has bonded thereto a first-order modifier is referred to as “first-order modified, hydrogenated copolymer (A)”.)

As examples of first-order modifiers having the above-mentioned functional groups, there can be mentioned the terminal modifiers described in Examined Japanese Patent Application Publication No. Hei 4-39495 (corresponding to U.S. Pat. No. 5,115,035) and WO03/8466. Specific examples of such modifiers include tetraglycidyl-m-xylene-diamine, tetraglycidyl-1,3-bis-aminomethylcyclohexane, ε-caprolactone, 4-methoxybenzophenone, γ-glycidoxyethyltrimethoxysilane, γ-glycidoxybutyltrimethoxysilane, γ-glycidoxypropyltriphenoxysilane, bis(γ-glycidoxypropyl)methyl-propoxysilane, 1,3-dimethyl-2-imidazolidinone, 1,3-diethyl-2-imidazolidinone, N,N′-dimethylpropylene-urea and N-methylpyrrolidone.

The modifier may comprise a first-order modifier and, bonded thereto, a second-order modifier. The second-order modifier has a functional group which is reactive to the functional group of the first-order modifier. (Hereinafter, a hydrogenated copolymer (A) having bonded thereto a modifier which comprises a first-order modifier and, bonded thereto, a second-order modifier is referred to as “second-order modified, hydrogenated copolymer (A)”.)

Examples of first-order modifiers used in the second-order modified, hydrogenated copolymer (A) include modifiers having at least one functional group selected from the group consisting of a hydroxyl group, a carboxyl group, a carbonyl group, a thiocarbonyl group, an acid halide group, an acid anhydride group, a carboxylic acid group, a thiocarboxyl group, an aldehyde group, a thioaldehyde group, a carboxylic ester group, an amide group, a sulfonic acid group, a sulfonic ester group, a phosphoric acid group, a phosphoric ester group, an amino group, an imino group, a nitrile group, a pyridyl group, a quinoline group, an epoxy group, a thioepoxy group, a sulfide group, an isocyanate group, an isothiocyanate group, a silicon halide group, a silanol group, an alkoxysilane group (which preferably has 1 to 24 carbon atoms), a tin halide group, an alkoxytin group and a phenyltin group. Preferred examples of first-order modifiers include modifiers having at least one functional group selected from the group consisting of a hydroxyl group, an epoxy group, an amino group, a silanol group and an alkoxysilane group (which preferably has 1 to 24 carbon atoms). Examples of first-order modifiers having the above-mentioned functional groups include the terminal modifiers described in the above-mentioned Examined Japanese Patent Application Publication No. Hei 4-39495 (corresponding to U.S. Pat. No. 5,115,035) and the above-mentioned WO03/8466.

Preferred examples of second-order modifiers include modifiers having at least one functional group selected from the group consisting of a carboxyl group, an acid anhydride group, an isocyanate group, an epoxy group, a silanol group and an alkoxysilane group (which preferably has 1 to 24 carbon atoms). It is especially preferred that the functional group of the second-order modifier comprises at least two members selected from the group consisting of the above-mentioned functional groups, wherein, when the at least two members include an acid anhydride group, it is preferred that only one of the at least two members is an acid anhydride group.

Specific examples of second-order modifiers are enumerated below. Specific examples of second-order modifiers having a carboxyl group include aliphatic carboxylic acids, such as maleic acid, oxalic acid, succinic acid, adipic acid, azelaic acid, sebacic acid, dodecanedicarboxylic acid, carbalic acid, cyclohexanedicarboxylic acid and cyclopentanedicarboxylic acid; and aromatic carboxylic acids, such as terephthalic acid, isophthalic acid, o-phthalic acid, naphthalenedicarboxylic acid, biphenyldicarboxylic acid, trimesic acid, trimellitic acid and pyromellitic acid.

Specific examples of second-order modifiers having an acid anhydride group include maleic anhydride, itaconic anhydride, pyromellitic anhydride, cis-4-cyclohexane-1,2-dicarboxylic acid anhydride, 1,2,4,5-benzenetetracarboxylic acid dianhydride, and 5-(2,5-dioxytetrahydroxyfuryl)-3-methyl-3-cyclohexene-1,2-dicarboxylic acid anhydride.

Specific examples of second-order modifiers having an isocyanate group include toluylene diisocyanate, diphenylmethane diisocyanate and multifunctional aromatic isocyanates.

Specific examples of second-order modifiers having an epoxy group include tetraglycidyl-1,3-bisamino-methylcyclohexane, tetraglycidyl-m-xylenediamine, di-glycidylaniline, ethylene glycol diglycidyl, propylene glycol diglycidyl, terephthalic acid diglycidyl ester acrylate, and the above-mentioned epoxy compounds which are exemplified as first-order modifiers used for obtaining the first-order modified, hydrogenated copolymer (A).

Specific examples of second-order modifiers having a silanol group include hydrolysis products of the above-mentioned alkoxysilane compounds which are exemplified as first-order modifiers used for obtaining the first-order modified, hydrogenated copolymer (A).

Specific examples of second-order modifiers having an alkoxysilane group having 1 to 24 carbon atoms include bis-(3-triethoxysilylpropyl)-tetrasulfane, bis-(3-triethoxysilylpropyl)-disulfane, ethoxysiloxane oligomers, and the above-mentioned silane compounds which are exemplified as first-order modifiers used for obtaining the first-order modified, hydrogenated copolymer (A).

Especially preferred examples of second-order modifiers used in the second-order modified, hydrogenated copolymer (A) include a carboxylic acid having two or more carboxyl groups and an anhydride thereof; and second-order modifiers having two or more of a group selected from the group consisting of an acid anhydride group, an isocyanate group, an epoxy group, a silanol group and an alkoxysilane group having 1 to 24 carbon atoms. Specific examples of especially preferred second-order modifiers include maleic anhydride, pyromellitic anhydride, 1,2,4,5-benzenetetracarboxylic acid dianhydride, toluylene diisocyanate, tetraglycidyl-1,3-bisaminomethylcyclohexane, and bis-(3-triethoxysilylpropyl)-tetrasulfane.

As mentioned above, when the modifier used in the modified, hydrogenated copolymer as component (A) comprises a first-order modifier, the modified, hydrogenated copolymer is referred to as “first-order modified, hydrogenated copolymer (A)”; and when the modifier used in the modified, hydrogenated copolymer as component (A) comprises a first-order modifier and, bonded thereto, a second-order modifier, the modified, hydrogenated copolymer is referred to as “second-order modified, hydrogenated copolymer (A)”.

With respect to the method for producing the first-order modified, hydrogenated copolymer as component (A), explanation is given below. The first-order modified, hydrogenated copolymer can be produced by a method in which the base unhydrogenated copolymer is hydrogenated to obtain a hydrogenated copolymer, and a first-order modifier is bonded to the obtained hydrogenated copolymer (hereinafter, this method is frequently referred to as “method in which the modification is performed after the hydrogenation”). Alternatively, the first-order modified, hydrogenated copolymer can be produced by a method in which a first-order modifier is bonded to the base unhydrogenated copolymer to obtain an unhydrogenated copolymer having bonded thereto a first-order modifier, and the obtained unhydrogenated copolymer having bonded thereto a first-order modifier is hydrogenated (hereinafter, this method is frequently referred to as “method in which the modification is performed before the hydrogenation”).

As an example of the method in which the modification is performed after the hydrogenation, there can be mentioned a method in which the base unhydrogenated copolymer is hydrogenated to obtain a hydrogenated copolymer, the obtained hydrogenated copolymer is reacted with an organic alkali metal compound (such as an organolithium compound) (this reaction is called a “metalation reaction”), thereby obtaining a hydrogenated copolymer having bonded thereto an alkali metal, followed by a reaction of the hydrogenated copolymer with a first-order modifier.

As an example of the method in which the modification is performed before the hydrogenation, there can be mentioned a method in which an unhydrogenated copolymer having a living terminal is obtained in the presence of an organolithium compound as a polymerization initiator by the above-mentioned method, the obtained unhydrogenated copolymer having a living terminal is reacted with a first-order modifier to obtain an unhydrogenated copolymer having bonded thereto a first-order modifier (this unhydrogenated copolymer is referred to as “modified, unhydrogenated copolymer”), and the modified, unhydrogenated copolymer is hydrogenated, thereby obtaining a first-order modified, hydrogenated copolymer. Further, a first-order modified, hydrogenated copolymer can also be produced by a method in which a base unhydrogenated copolymer which does not have a living terminal is reacted with an organic alkali metal compound (such as an organolithium compound) (this reaction is called “metalation reaction”), thereby obtaining a unhydrogenated copolymer having bonded to an alkali metal, the unhydrogenated copolymer having bonded to an alkali metal is reacted with a first-order modifier to obtain a modified, unhydrogenated copolymer, and the modified, unhydrogenated copolymer is hydrogenated, thereby obtaining a first-order modified, hydrogenated copolymer.

In either of the method in which the modification is performed after the hydrogenation and the method in which the modification is performed before the hydrogenation, the modification reaction temperature is preferably in the range of from 0 to 150° C., more preferably 20 to 120° C. The modification reaction time varies depending on other conditions, but is preferably within 24 hours, more preferably in the range of from 0.1 to 10 hours.

When the base unhydrogenated copolymer is reacted with a first-order modifier, it is possible that a hydroxyl group, an amino group and the like, which are contained in the first-order modifier, are converted to organic metal salts thereof, depending on the type of first-order modifier. In such case, the organic metal salts can be reconverted to a hydroxyl group, an amino group and the like by reacting the organic metal salts with an active hydrogen-containing compound, such as water or an alcohol.

The first-order modified, hydrogenated copolymer, which is obtained by reacting the living terminals of the base unhydrogenated copolymer with the first-order modifier, followed by hydrogenation, may contain an unmodified copolymer fraction. The amount of such unmodified copolymer fraction in the first-order modified, hydrogenated copolymer is preferably not more than 70% by weight, more preferably not more than 60% by weight, still more preferably not more than 50% by weight, based on the weight of the first-order modified, hydrogenated copolymer.

With respect to the method for producing the second-order modified, hydrogenated copolymer, explanation is given below. The second-order modified, hydrogenated copolymer is obtained by reacting the above-mentioned, first-order modified, hydrogenated copolymer with a second-order modifier.

When the first-order modified, hydrogenated copolymer is reacted with the second-order modifier, the amount of the second-order modifier is generally from 0.3 to 10 mol, preferably from 0.4 to 5 mol, more preferably from 0.5 to 4 mol, relative to one equivalent of the functional group of the first-order modifier bonded to the first-order modified, hydrogenated copolymer.

With respect to the method for reacting the first-order modified, hydrogenated copolymer with the second-order modifier, there is no particular limitation, and a conventional method can be employed. Examples of conventional methods include a method using melt-kneading (described below) and a method in which the components are reacted with each other in a state in which they are dissolved or dispersed together in a solvent. In the latter, there is no particular limitation with respect to the solvent so long as the solvent is capable of dissolving or dispersing each of the components. Examples of solvents include hydrocarbons, such as an aliphatic hydrocarbon, an alicyclic hydrocarbon and an aromatic hydrocarbon; halogen-containing solvents; ester solvents; and ether solvents. In the method in which the components are dissolved or dispersed together in a solvent, the temperature at which the first-order modified, hydrogenated copolymer is reacted with the second-order modifier is generally from −10 to 150° C., preferably from 30 to 120° C. In this method, the reaction time varies depending on other conditions, but is generally within 3 hours, preferably in the range of from several seconds to 1 hour. As an especially preferred method for producing the second-order modified, hydrogenated copolymer, there can be mentioned a method in which the second-order modifier is added to a solution of the first-order modified, hydrogenated copolymer to thereby effect a reaction, thus obtaining a second-order modified, hydrogenated copolymer. In this method, the solution of the first-order modified, hydrogenated copolymer may be subjected to neutralization treatment before the addition of the second-order modifier to the solution of the first-order modified, hydrogenated copolymer.

The hydrogenated copolymer (which is unmodified) as component (A) can be graft-modified using an α,β-unsaturated carboxylic acid or a derivative (such as an anhydride, an ester, an amide or an imide) thereof. Specific examples of α,β-unsaturated carboxylic acids and derivatives thereof include maleic anhydride, maleimide, acrylic acid, an acrylic ester, methacrylic acid, a methacrylic ester, and endo-cis-bicyclo(2,2,1)-5-heptene-2,3-dicarboxylic acid and an anhydride thereof.

The amount of the α,β-unsaturated carboxylic acid or derivative thereof is generally in the range of from 0.01 to 20 parts by weight, preferably from 0.1 to 10 parts by weight, relative to 100 parts by weight of the hydrogenated copolymer.

When the hydrogenated copolymer is subjected to a graft-modification reaction, the graft-modification reaction is performed preferably at 100 to 300° C., more preferably at 120 to 280° C.

With respect to the details of the method for the graft-modification, reference can be made, for example, to Unexamined Japanese Patent Application Laid-Open Specification No. Sho 62-79211.

When the hydrogenated copolymer (A) is a first-order modified, hydrogenated copolymer or a second-order modified, hydrogenated copolymer, with respect to the modifier bonded to the hydrogenated copolymer (A) (i.e., the first-order modifier (in the case of the first-order modified, hydrogenated copolymer), or both the first-order modifier and the second-order modifier (in the case of the second-order modified, hydrogenated copolymer)), the functional group thereof not only is reactive to the polymer (B), an inorganic filler, an polar group-containing additive and the like, but also has a nitrogen atom, an oxygen atom or a carbonyl group, so that the interaction between the functional group of the modifier and the polar group of the polymer (B), inorganic filler, polar group-containing additive or the like is effectively exerted due to a physical affinity (such as hydrogen bond) therebetween, thereby enhancing the excellent properties of the polymer foam of the present invention. Such enhancement of the excellent properties of the polymer foam can also be achieved when the hydrogenated copolymer (A) is graft-modified as mentioned above.

As mentioned above, the amount of the hydrogenated copolymer as component (A) (wherein the hydrogenated copolymer may be a first-order modified, hydrogenated copolymer or a second-order modified, hydrogenated copolymer) and the amount of the polymer as component (B) are, respectively, 5 to 100 parts by weight and 95 to 0 part by weight, relative to 100 parts by weight of the total of components (A) and (B). It is preferred that the amounts of components (A) and (B) are, respectively, 5 to 95 parts by weight and 95 to 5 parts by weight, relative to 100 parts by weight of the total of components (A) and (B). It is more preferred that the amounts of components (A) and (B) are, respectively, 20 to 65 parts by weight and 80 to 35 parts by weight, relative to 100 parts by weight of the total of components (A) and (B).

When component (A) is a modified, hydrogenated copolymer (i.e., a first-order modified, hydrogenated copolymer or a second-order modified, hydrogenated copolymer), a portion (of component (A)) other than the modifier is referred to as “component (A-1)”. The amount of the modifier is generally from 0.01 to 20 parts by weight, preferably from 0.02 to 10 parts by weight, more preferably from 0.05 to 7 parts by weight, relative to 100 parts by weight of the total of components (A-1) and (B). The weight ratio of component (A-1) to component (B) is preferably from 10/90 to 90/10, more preferably from 20/80 to 65/35.

As mentioned above, the polymer (B) is at least one member selected from the group consisting of an olefin polymer other than the hydrogenated copolymer (A) and a rubbery polymer other than the hydrogenated copolymer (A).

With respect to the olefin polymer as component (B), there is no particular limitation. Examples of olefin polymers (B) include: ethylene polymers, such as a polyethylene, a copolymer of ethylene with a comonomer copolymerizable with ethylene (wherein the ethylene monomer unit content is 50% by weight or more) (e.g., an ethylene/propylene copolymer, an ethylene/propylene/butylene copolymer, an ethylene/butylene copolymer, an ethylene/hexene copolymer, an ethylene/octene copolymer, an ethylene/vinyl acetate copolymer or a hydrolysis product thereof, a copolymer of ethylene with an acrylic ester (which is obtained by a reaction of acrylic acid with an alcohol having 1 to 24 carbon atoms or glycidyl alcohol) (e.g., methyl acrylate, ethyl acrylate, propyl acrylate, butyl acrylate, pentyl acrylate or hexyl acrylate), or a copolymer of ethylene with an methacrylic ester (which is obtained by a reaction of methacrylic acid with an alcohol having 1 to 24 carbon atoms or glycidyl alcohol) (e.g., methyl methacrylate, ethyl methacrylate, propyl methacrylate, butyl methacrylate, pentyl methacrylate or hexyl methacrylate), an ethylene/acrylic acid ionomer, and a chlorinated polyethylene; propylene polymers, such as a polypropylene, a copolymer of propylene with a comonomer copolymerizable with propylene (wherein the propylene monomer unit content is 50% by weight or more), such as a propylene/ethylene copolymer, a propylene/ethylene/butylene copolymer, a propylene/butylene copolymer, a propylene/hexene copolymer, propylene/octene copolymer, a copolymer of propylene with any of the above-mentioned acrylic esters, or a copolymer of propylene with any of the above-mentioned methacrylic esters, and a chlorinated polypropylene; cyclic olefin polymers (e.g., an ethylene/norbornene polymer); and butene polymers.

Of the above-mentioned olefin polymers, preferred are ethylene polymers. Preferred examples of ethylene polymers include a polyethylene, an ethylene/propylene copolymer, an ethylene/propylene/butylene copolymer, an ethylene/butylene copolymer, an ethylene/hexene copolymer, an ethylene/octene copolymer, an ethylene/vinyl acetate copolymer, an ethylene/acrylic ester copolymer and an ethylene/methacrylic ester copolymer.

The above-mentioned olefin polymers can be used individually or in combination. When the olefin polymer is a copolymer, the olefin polymer may or may not be a block copolymer.

With respect to the method for producing the olefin polymer (B), there is no particular limitation, and a conventional method can be employed. For example, the olefin polymer (B) can be produced by transition polymerization, radical polymerization, ionic polymerization or the like.

When the polymer foam of the present invention is required to have excellent processability, the melt flow rate of the olefin polymer (B) as measured in accordance with JIS K6758 at 230° C. under a load of 2.16 kg is preferably from 0.05 to 200 g/10 min, more preferably from 0.1 to 150 g/10 min. The olefin polymer (B) may be preliminarily modified with the second-order modifier.

With respect to the rubbery polymer as component (B), there is no particular limitation. Examples of rubbery polymers (B) include a conjugated diene polymer (such as a butadiene rubber or an isoprene rubber) and a hydrogenation product thereof, a copolymer comprised of vinyl aromatic monomer units and conjugated diene monomer units (such as a styrene/butadiene rubber) and a hydrogenation product thereof, a block copolymer comprised of a homopolymer block of vinyl aromatic monomer units and at least one polymer block selected from the group consisting of a homopolymer block of conjugated diene monomer units and a copolymer block comprised of vinyl aromatic monomer units and conjugated diene monomer units (such as a styrene/butadiene block copolymer or a styrene/isoprene block copolymer) and a hydrogenation product thereof, an acrylonitrile/butadiene rubber and a hydrogenation product thereof, a chloroprene rubber, an ethylene/propylene/diene rubber (EPDM), an ethylene/butene/diene rubber, a butyl rubber, an acrylic rubber, a fluorine rubber, a silicone rubber, a chlorinated polyethylene rubber, an epichlorohydrin rubber, an α,β-unsaturated nitrile/acrylic ester/conjugated diene copolymer rubber, a urethane rubber, a polysulfide rubber and a natural rubber. These rubbery polymers can be used individually or in combination.

Each of the above-mentioned rubbery polymers may be a modified rubber having bonded thereto a functional group. For example, the rubbery polymer may be a modified rubber which is modified with the second-order modifier.

The weight average molecular weight of the rubbery polymer is generally from 30,000 to 1,000,000, preferably from 50,000 to 800,000, more preferably from 70,000 to 500,000. The weight average molecular weight of the rubbery polymer is measured by GPC.

Of the above-mentioned rubbery polymers, preferred are a 1,2-polybutadiene, a hydrogenation product of a conjugated diene homopolymer, a copolymer comprised of vinyl aromatic monomer units and conjugated diene monomer units and a hydrogenation product thereof, a block copolymer comprised of a homopolymer block of vinyl aromatic monomer units and at least one polymer block selected from the group consisting of a homopolymer block of conjugated diene monomer units and a copolymer block comprised of vinyl aromatic monomer units and conjugated diene monomer units and a hydrogenation product thereof, an acrylonitrile/butadiene rubber and a hydrogenation product thereof, an ethylene/propylene/diene rubber (EPDM), a butyl rubber and a natural rubber.

Of the above-mentioned rubbery polymers, from the viewpoint of the shock-absorbing property (low impact resilience) of the polymer foam, more preferred are a hydrogenation product of a copolymer comprised of vinyl aromatic monomer units and conjugated diene monomer units, wherein the hydrogenation product has a vinyl aromatic monomer unit content of from more than 60% by weight to 90% by weight, based on the weight of the hydrogenation product; and a block copolymer comprised of a homopolymer block of vinyl aromatic monomer units and at least one polymer block selected from the group consisting of a homopolymer block of conjugated diene monomer units and a copolymer block comprised of vinyl aromatic monomer units and conjugated diene monomer units and a hydrogenation product thereof.

In the present invention, a material comprising 5 to 100 parts by weight of the hydrogenated copolymer (A) and 95 to 0 part by weight of the polymer (B) (wherein the amounts of components (A) and (B) are indicated in terms of parts by weight, relative to 100 parts by weight of the total of components (A) and (B)) is used for producing the polymer foam. This material constitutes the polymer matrix of the polymer foam of the present invention. Hereinafter, the material (which comprises component (A) or a mixture of components (A) and (B)) is referred to as “matrix-forming material”.

The matrix-forming material may further comprise a thermoplastic resin other than an olefin polymer used as component (B). When the matrix-forming material contains a thermoplastic resin other than an olefin polymer, from the viewpoint of maintaining the flexibility of the polymer foam, the amount of the thermoplastic resin is generally from 1 to 100 parts by weight, preferably from 5 to 80 parts by weight, relative to 100 parts by weight of the total of components (A) and (B).

Examples of thermoplastic resins other than an olefin polymer include a copolymer resin of any of the vinyl aromatic monomers (which are enumerated above in connection with component (A)) with at least one vinyl monomer (other than the vinyl aromatic monomer), such as ethylene, propylene, butylene, vinyl chloride, vinylidene chloride, vinyl acetate, acrylic acid, an acrylic ester (e.g., methyl acrylate), methacrylic acid, a methacrylic ester (e.g., methyl methacrylate), acrylonitrile or methacrylonitrile; a rubber-modified styrene resin (HIPS); an acrylonitrile/butadiene/styrene copolymer resin (ABS); and a methacrylic ester/butadiene/styrene copolymer resin (MBS).

Further examples of thermoplastic resins include a polyvinyl chloride, a polyvinylidene chloride, a vinyl chloride resin, a vinyl acetate resin and a hydrolysis product thereof, a polymer of acrylic acid and a polymer of an ester or amide thereof, a polymer of methacrylic acid and a polymer of an ester or amide thereof, an acrylate resin, a polyacrylonitrile, a polymethacrylonitrile, an acrylonitrile/methacrylonitrile copolymer, and a nitrile resin which is a copolymer of an acrylonitrile type monomer with a comonomer copolymerizable with the acrylonitrile type monomer (wherein the acrylonitrile type monomer unit content is 50% by weight or more).

Further examples of thermoplastic resins include polyamide resins, such as nylon-46, nylon-6, nylon-66, nylon-610, nylon-11, nylon-12 and a nylon-6/nylon-12 copolymer; a polyester resin; a thermoplastic polyurethane resin; polycarbonates, such as poly-4,4′-dioxydiphenyl-2,2′-propane carbonate; thermoplastic polysulfones, such as a polyether sulfone and a polyallyl sulfone; an polyoxymethylene resin; polyphenylene ether resins, such as a poly(2,6-dimethyl-1,4-phenylene) ether; polyphenylene sulfide resins, such as a polyphenylene sulfide and a poly-4,4′-diphenylene sulfide; a polyallylate resin; an ether ketone homopolymer or copolymer; a polyketone resin; a fluororesin; a polyoxybenzoyl type polymer; a polyimide resin; and butadiene polymer resins, such as a transpolybutadiene.

The above-mentioned thermoplastic resins can be used individually or in combination.

The thermoplastic resin may have been preliminarily modified with the second-order modifier.

The number average molecular weight of the thermoplastic resin is generally 1,000 or more, preferably from 5,000 to 5,000,000, more preferably from 10,000 to 1,000,000. The number average molecular weight of the thermoplastic resin is measured by GPC.

For improving the processability of the matrix-forming material, the matrix-forming material may contain a softening agent. As the softening agent, it is preferred to use a mineral oil, or a liquid or low molecular weight synthetic softening agent. In general, a mineral oil type softening agent (called “process oil” or “extender oil”) which is generally used for increasing the volume of a rubber or for improving the processability of a rubber is a mixture of an aromatic compound, a naphthene and a chain paraffin. With respect to the mineral oil type softening agents, a softening agent in which the number of carbon atoms constituting the paraffin chains is 50% or more (based on the total number of carbon atoms present in the softening agent) is referred to as “paraffin type softening agent”; a softening agent in which the number of carbon atoms constituting the naphthene rings is from 30 to 45% (based on the total number of carbon atoms present in the softening agent) is referred to as “naphthene type softening agent”; and a softening agent in which the number of carbon atoms constituting the aromatic rings is more than 30% (based on the total number of carbon atoms present in the softening agent) is referred to as “aromatic type softening agent”. It is preferred that the mineral oil type softening agent is at least one member selected from the group consisting of a naphthene type softening agent and a paraffin type softening agent.

As a synthetic softening agent, there can be used a polybutene, a low molecular weight polybutadiene and a liquid paraffin. However, the above-mentioned mineral oil type-softening agent is more preferred.

The amount of the softening agent is generally in the range of from 0 to 200 parts by weight, preferably from 0 to 100 parts by weight, relative to 100 parts by weight of the hydrogenated copolymer (A).

If desired, the matrix-forming material may contain an additive. With respect to the additive, there is no particular limitation so long as it is conventionally used in thermoplastic resins or rubbery polymers.

Examples of additives include inorganic fillers, such as silica, talc, mica, calcium silicate, hydrotalcite, kaolin, diatomaceous earth, graphite, calcium carbonate, magnesium carbonate, magnesium hydroxide, aluminum hydroxide, calcium sulfate and barium sulfate; and organic fillers, such as carbon black.

Further examples of additives include lubricants, such as stearic acid, behenic acid, zinc stearate, calcium stearate, magnesium stearate and ethylene bis-stearamide; old release agents; plasticizers, such as an organopolysiloxane and a mineral oil; antioxidants, such as a hindered phenol type antioxidant, a phosphorus type thermal stabilizer, a sulfur type thermal stabilizer and an amine type thermal stabilizer; hindered amine type light stabilizers; benzotriazole type ultraviolet absorbers; flame retardants; antistatic agents; reinforcing agents, such as an organic fiber, a glass fiber, a carbon fiber and a metal whisker; coloring agents, such as titanium oxide, iron oxide and carbon black; and additives (other than mentioned above) which are described in “Gomu Purasuchikku Haigou Yakuhin (Additives for Rubber and Plastic)” (Rubber Digest Co., Ltd., Japan).

The polymer foam of the present invention has a specific gravity of from 0.05 to 0.5, preferably from 0.1 to 0.3. By virtue of the fact that the polymer foam of the present invention has a specific gravity of from 0.05 to 0.5, the polymer foam has excellent mechanical properties (such as excellent tensile strength and excellent tearing strength), is light in weight, and is very economical. The specific gravity of the polymer foam is measured by means of an automatic specific gravity measuring apparatus.

The specific gravity of the polymer foam can be adjusted by appropriately choosing the types and amounts of the below-mentioned crosslinking agent and crosslinking accelerator, and the crosslinking conditions (such as the crosslinking temperature and the crosslinking time).

With respect to the impact resilience of the polymer foam of the present invention, it is preferred that the impact resilience is 40% or less, more advantageously 35% or less, still more advantageously 30% or less. In the present invention, the impact resilience of the polymer foam is defined as follows. A sample of the polymer foam, having a thickness of from 15 to 17 mm, is placed on a plate having a flat surface. At 22° C., a steel ball having a weight of 16.3 g is allowed to fall from the fall height above the sample to cause the ball to collide against the sample. The impact resilience of the polymer foam is defined by the following formula:
Impact resilience (%)=(HR/HO)×100,
wherein HO represents the fall height of the ball, and HR represents the resilience height of the ball after the collision of the ball against the sample.

The smaller the impact resilience of the polymer foam, the better the shock-absorbing property of the polymer foam.

The polymer foam of the present invention has excellent properties with respect to flexibility, low temperature characteristics (such as flexibility at low temperatures), shock-absorbing property (low impact resilience), compression set resistance and the like, so that the polymer foam can be advantageously used as a shock absorber (especially a footwear material) and the like.

With respect to the method for producing the polymer foam of the present invention, there is no particular limitation. Fundamentally, the polymer foam can be produced by adding a foaming agent to the matrix-forming material, and causing the matrix-forming material to foam, thereby obtaining a polymer foam in which cells are distributed in a polymer matrix. Examples of foaming agents include a chemical foaming agent and a physical foaming agent.

When a chemical foaming agent is used for foaming the matrix-forming material, the polymer foam can be produced by a method comprising the following three steps:

(1) providing a matrix-forming material,

(2) adding a chemical foaming agent to the matrix-forming material, and kneading the resultant mixture to obtain a foamable material, and

(3) causing the foamable material obtained in step (2) to foam, thereby obtaining a polymer foam.

In step (1), a matrix-forming material is provided. With respect to the method for providing the matrix-forming material, there is no particular limitation. For example, the matrix-forming material can be provided by feeding the components for the matrix-forming material to a kneading machine and melt-kneading the resultant mixture to obtain a matrix-forming material. Examples of kneading machines include conventional mixing machines, such as a roll kneading machine (open mill having two rolls), a Banbury mixer, a kneader, a Ko-kneader, a single-screw extruder, a twin-screw extruder and a multi-screw extruder. In the present invention, from the viewpoint of productivity and kneadability, it is preferred to use a melt-kneading method using an extruder. The kneading temperature is generally in the range of from 80 to 250° C., preferably from 100 to 230° C. The kneading time is generally in the range of from 4 to 80 minutes, preferably from 8 to 40 minutes.

The matrix-forming material can also be provided by a method in which the components for the matrix-forming material are dissolved or dispersed in a solvent, followed by removal of the solvent by heating.

In step (2), to the matrix-forming material are added a foaming agent and, if desired, a crosslinking agent (and a crosslinking accelerator), thereby obtaining a foamable material. As the kneading machine for use in step (2), any of the kneading machines enumerated above in connection with step (1) can be used. The kneading temperature is generally in the range of from 60 to 200° C., preferably from 80 to 150° C. The kneading time is generally in the range of from 3 to 60 minutes, preferably from 6 to 30 minutes. When a crosslinking agent is used, it is necessary to perform the kneading at a temperature at which the crosslinking reaction does not proceed to excess. The range of the temperatures at which the crosslinking reaction does not proceed to excess varies depending on the type of the crosslinking agent used. For example, when dicumyl peroxide is used as the crosslinking agent, it is necessary to perform the kneading at a temperature of from 80 to 130° C.

The kneading machine (used in step (1)) as such may be used again for the kneading performed in step (2).

As the chemical foaming agent for use in step (2), there can be mentioned an inorganic foaming agent and an organic foaming agent.

Examples of inorganic foaming agents include sodium bicarbonate, ammonium carbonate, ammonium bicarbonate, ammonium nitrite, an azide compound, sodium borohydride and a metal powder.

Examples of organic foaming agents include azodicarbonamide, azobisformamide, azobisisobutylonitrile, barium azodicarboxylate, diazoaminoazobenzene, N,N′-dinitrosopentamethylenetetramine, N,N′-dinitroso-N,N′-dimethylterephtalamide, benzenesulfonylhydrazide, p-toluenesulfonylhydrazide, p,p′-oxy-bis(benzenesulfonylhydrazide) and p-toluenesulfonyl-semicarbazide.

The above-mentioned chemical foaming agents can be used individually or in combination.

The amount of the chemical foaming agent is generally from 0.1 to 10 parts by weight, preferably from 0.3 to 8 parts by weight, more preferably from 0.5 to 6 parts by weight, still more preferably from 1 to 5 parts by weight, relative to 100 parts by weight of the total of components (A) and (B).

In step (2), if desired, a crosslinking agent (vulcanizing agent) can be used. When a crosslinking agent is used in step (2), crosslinking (vulcanization) occurs simultaneously with the occurrence of foaming in the subsequent step (3).

Examples of crosslinking agents for use in step (2) include a radical generator (such as an organic peroxide or an azo compound), an oxime, a nitroso compound, a polyamine, sulfur and a sulfur-containing compound. Examples of sulfur-containing compounds include sulfur monochloride, sulfur dichloride, a disulfide compound and a high molecular weight polysulfide compound. The amount of the crosslinking agent is generally from 0.01 to 20 parts by weight, preferably from 0.1 to 15 parts by weight, more preferably from 0.5 to 10 parts by weight, relative to 100 parts by weight of the total of components (A) and (B). When it is intended to use the polymer foam as a shock absorber, the amount of the crosslinking agent is preferably from 0.8 to 10 parts by weight, more preferably from 1 to 8 parts by weight, relative to 100 parts by weight of the total of components (A) and (B).

Examples of organic peroxides include dicumyl peroxide, di-tert-butyl peroxide, benzoyl peroxide, p-chlorobenzoyl peroxide, 2,4-dichlorobenzoyl peroxide, tert-butyl cumyl peroxide, tert-butylperoxyisopropyl carbonate, diacetyl peroxide, lauroyl peroxide, cyclohexanone peroxide, tert-butyl hydroperoxide, methyl ethyl ketone peroxide, tert-butyl peroxybenzoate, di-tert-butyldiperoxy phthalate, tert-butylperoxy laurate and tert-butylperoxy acetate.

Further examples of organic peroxides include n-butyl-4,4-bis(tert-butylperoxy)valerate, tert-butylperoxy maleiate, 2,2-bis(tert-butylperoxy)butane, 1,1-di(tert-butylperoxy)cyclohexane, 2,5-dimethyl-2,5-di(tert-butylperoxy)hexane, 2,5-dimethyl-2,5-di(tert-butylperoxy)hexyne-3,2,5-dimethyl-2,5-di(benzoyl peroxy)hexane, 2,5-dimethyl-2,5-di(benzoyl peroxy)hexyne-3,2,2-bis(butylperoxyisopropyl)benzene, 1,3-bis(tert-butylperoxyisopropyl)benzene, 1,1-bis(tert-butylperoxy)-3,3,5-trimethylcyclohexane, and 1,1-bis(tert-butylperoxy)-3,5,5-trimethylcyclohexane.

Of the above-mentioned organic peroxides, from the viewpoint of low odor and scorch stability, preferred are dicumyl peroxide, 2,5-dimethyl-2,5-di(tert-butylperoxy)hexane, 2,5-dimethyl-2,5-di(tert-butylperoxy)hexyne-3,1,3-bis(tert-butylperoxyisopropyl)benzene, 1,1-bis(tert-butylperoxy)-3,3,5-trimethylcyclohexane, n-butyl-4,4-bis(tert-butylperoxy)valerate and di-tert-butyl peroxide.

Further, when the above-mentioned organic peroxide is used, an auxiliary crosslinking agent (crosslinking accelerator) can be used in combination with the organic peroxide. Examples of auxiliary crosslinking agents (crosslinking accelerators) include sulfur, p-quinone dioxime, p,p′-dibenzoylquinone dioxime, N-methyl-N-4-dinitrosoaniline, nitrosobenzene, diphenylguanidine, trimethylolpropane-N,N′-m-phenylenedimaleimide, divinylbenzene, triallyl cyanurate triallyl isocyanurate, multifunctional acrylate monomers (such as butylene glycol acrylate, diethylene glycol diacrylate and a metal acrylate), multifunctional methacrylate monomers (such as butylene glycol methacrylate, ethylene glycol dimethacrylate, diethylene glycol dimethacrylate, a polyethylene glycol dimethacrylate, trimethylol propane trimethacrylate, allyl methacrylate and a metal methacrylate), and multifunctional vinyl monomers (such as vinyl butylate and vinyl stearate).

The amount of the auxiliary crosslinking agent (crosslinking accelerator) is generally from 0.01 to 20 parts by weight, preferably from 0.05 to 15 parts by weight, more preferably from 0.1 to 10 parts by weight, relative to 100 parts by weight of the total of components (A) and (B). Especially when the polymer foam of the present invention is used as a shock absorber, the amount of the auxiliary crosslinking agent (crosslinking accelerator) is preferably from 0.1 to 5 parts by weight.

Further, when sulfur is used as the crosslinking agent, any of the following auxiliary crosslinking agents can be used in combination with sulfur: a sulphenic amide type auxiliary crosslinking agent, a guanidine type auxiliary crosslinking agent, a thiuram type auxiliary crosslinking agent, an aldehyde-amine type auxiliary crosslinking agent, an aldehyde-ammonia type auxiliary crosslinking agent, a thiazole type auxiliary crosslinking agent, a thiourea type auxiliary crosslinking agent and a dithiocarbamate type auxiliary crosslinking agent. Further, zinc white or stearic acid can also be used as an auxiliary crosslinking agent in combination with sulfur.

In step (3), the foamable material obtained in step (2) is caused to foam to obtain a polymer foam. With respect to the method for causing the foamable material to foam, there is no particular limitation. For example, the polymer foam can be obtained by feeding the foamable material to a compression molding machine, a roll mill, a calender roll, an extruder or an injection molding machine, followed by effecting foaming of the foamable material to obtain a polymer foam.

With respect to the method using a compression molding machine, explanation is given below. The foamable material obtained in step (2) is fed to a compression molding machine, and a compression molding is performed at 100 to 220° C. (preferably 120 to 200° C.) under 50 to 250 kgf/cm² (preferably 100 to 200 kgf/cm²) for 4 to 80 minutes (preferably 8 to 40 minutes) to thereby obtain a compressed, foamable material. 5 to 60 minutes after completion of the compression molding, the temperature in the compression molding machine is lowered to room temperature while maintaining the pressure in the compression molding machine. Then, the pressure in the compression molding machine is relieved to effect foaming of the compressed, foamable material, thereby obtaining a polymer foam.

The polymer foam can be obtained in the forms of various shaped articles, such as a sheet. When a crosslinking agent is used in combination with a foaming agent in step (2), crosslinking occurs simultaneously with the occurrence of foaming in step (3), so that the polymer foam is obtained in the form of a crosslinked polymer foam. When the polymer foam is in the form of a crosslinked polymer foam, the strength of the polymer foam is enhanced.

When a physical foaming agent is used as the foaming agent, the polymer foam can be obtained, for example, by a method comprising the following three steps:

(1) providing a matrix-forming material,

(2) adding a physical foaming agent to the matrix-forming material, and kneading the resultant mixture under pressure to obtain a foamable material, and

(3) allowing the foamable material obtained in step (2) to stand under atmospheric pressure to cause the foamable material to foam, thereby obtaining a polymer foam.

In step (1), a matrix-forming material is provided in substantially the same manner as in step (1) of the above-mentioned method using a chemical foaming agent.

With respect to steps (2) and (3), explanation is given below, taking an extrusion foaming process as an example.

In step (2), the matrix-forming material is fed together with a foaming agent to an extruder, and the resultant mixture is melt-kneaded at 100 to 200° C. under 10 to 100 kgf/cm² to thereby disperse or dissolve the foaming agent in the matrix-forming material, thereby obtaining a foamable material.

In step (3), the foamable material is extruded in the air through a die provided at the terminal of the extruder to thereby effect foaming of the foamable material, thereby obtaining a polymer foam.

In the extrusion foaming process, the foaming of the foamable material is caused to occur due to the expansion force of the physical foaming agent.

Examples of physical foaming agents include hydrocarbons, such as pentane, butane and hexane; halogenated hydrocarbons, such as methyl chloride and methylene chloride; gases, such as nitrogen gas and air; and fluorinated hydrocarbons, such as trichlorofluoromethane, dichlorodifluoromethane, trichlorotrifluoroethane, chlorodifluoroethane and a hydrofluorocarbon.

The amount of the physical foaming agent is generally from 0.1 to 8 parts by weight, preferably from 0.2 to 6 parts by weight, more preferably from 0.3 to 4 parts by weight, relative to 100 parts by weight of the total of components (A) and (B).

In step (2), if desired, a crosslinking agent (vulcanizing agent) can be used. When a crosslinking agent is used in step (2), crosslinking occurs simultaneously with the occurrence of foaming in the subsequent step (3). With respect to the type and amount of the crosslinking agent, the same explanation as given above in connection with the method using a chemical foaming agent can apply.

### BEST MODE FOR CARRYING OUT THE INVENTION

Hereinbelow, the present invention will be described in more detail with reference to the following Examples and Comparative Example, which should not be construed as limiting the scope of the present invention.

The properties of copolymers and foams were measured by the below-mentioned methods.

A. Properties of Copolymers

(1) Styrene Monomer Unit Content

The styrene monomer unit content of the base unhydrogenated copolymer was determined by means of an ultraviolet spectrophotometer (trade name: UV-2450; manufactured and sold by Shimadzu Corporation, Japan). The styrene monomer unit content of the base unhydrogenated copolymer was used as the styrene monomer unit content of the hydrogenated copolymer.

(2) Styrene Polymer Block Content

The styrene polymer block content of the base unhydrogenated copolymer was determined by the osmium tetraoxide degradation method described in I. M. Kolthoff et al., J. Polym. Sci. vol. 1, p. 429 (1946). For the degradation of the base unhydrogenated copolymer, a solution obtained by dissolving 0.1 g of osmic acid in 125 ml of tertiary butanol was used.

(3) Vinyl Bond Content

The vinyl bond content in the base unhydrogenated copolymer was calculated by the Hampton method, based on the results of a measurement using an infrared spectrophotometer (trade name: FT/IR-230; manufactured and sold by Japan Spectroscopic Co., Ltd., Japan).

(4) Hydrogenation Ratio

The hydrogenation ratio was measured by means of a nuclear magnetic resonance (NMR) apparatus (trade name: DPX-400; manufactured and sold by BRUKER, Germany).

(5) Weight Average Molecular Weight and Molecular Weight Distribution

The weight average molecular weight and number average molecular weight of the base unhydrogenated copolymer were measured by gel permeation chromatography (GPC) using a GPC apparatus (manufactured and sold by Waters Corporation, U.S.A.) under conditions wherein tetrahydrofuran was used as a solvent and the measuring temperature was 35° C. In the measurement of the weight average molecular weight and number average molecular weight of the base unhydrogenated copolymer, there was used a calibration curve obtained with respect to commercially available standard monodisperse polystyrene samples having predetermined molecular weights. The molecular weight distribution is the ratio (Mw/Mn) of the weight average molecular weight (Mw) to the number average molecular weight (Mn).

(6) Modification Ratio

A modified copolymer adsorbs on a silica gel column but not on a polystyrene gel column. Based on such a unique property of the modified copolymer, the modification ratio of the modified copolymer was determined by the following method. A sample solution containing a modified copolymer sample and a low molecular weight internal standard polystyrene is prepared, and the prepared sample solution is subjected to GPC using a standard type polystyrene gel column (trade name: Shodex; manufactured and sold by Showa Denko Co., Ltd., Japan), which is the same as used in item (5) above, thereby obtaining a chromatogram. On the other hand, another chromatogram is obtained by subjecting the same sample solution to GPC in substantially the same manner as mentioned above, except that a silica gel column (trade name: Zorbax; manufactured and sold by DuPont de Nemours & Company Inc., U.S.A.) is used in place of the standard type polystyrene gel column. From the difference between the chromatogram obtained using the polystyrene gel column and the chromatogram obtained using the silica gel column, the amount of the copolymer fraction (contained in the modified copolymer) having adsorbed on the silica gel column is determined. From the determined amount of the copolymer fraction, the modification ratio of the modified copolymer is obtained.

(7) Temperature at Which a Peak of Loss Tangent (tanδ) is Observed

A dynamic viscoelastic spectrum was obtained by means of a dynamic viscoelastic spectrum analyzer (type: DVE-V4; manufactured and sold by Rheology Co., Ltd., Japan), wherein the analysis was performed at a frequency of 10 Hz. From the dynamic viscoelastic spectrum, the temperature at which a peak of loss tangent (tanδ) was observed was obtained.

(8) Crystallization Peak and Quantity of Heat at the Crystallization Peak

Using a differential scanning calorimeter (DSC) (trade name: DSC3200S; manufactured and sold by MAC Science Co., Ltd., Japan), the crystallization peak of the hydrogenated copolymer and the quantity of heat at the crystallization peak were measured by the following method. The hydrogenated copolymer is fed to the differential scanning calorimeter. The internal temperature of the differential scanning calorimeter is elevated at a rate of 30° C./min from room temperature to 150° C. and, then, lowered at a rate of 10° C./min from 150° C. to −100° C., thereby obtaining a DSC chart (i.e., crystallization curve) with respect to the hydrogenated copolymer. From the obtained DSC chart, whether or not the crystallization peak is present is confirmed. When a crystallization peak is observed in the DSC chart, the temperature at which the crystallization peak is observed is defined as the crystallization peak temperature, and the quantity of heat at the crystallization peak is measured.

B. Properties of Foams

(1) Specific Gravity of the Foam

The specific gravity of the foam was measured by means of an automatic specific gravity measuring apparatus (trade name: Automatic Sp. Gr. Calibrator DMA3; manufactured and sold by Ueshima Seisakusho Co., Ltd., Japan).

(2) Hardness

In accordance with ASTM-D2240, the hardness of the foam was measured at 22° C. and −10° C. by means of an Asker C type durometer (KOUBUNSHI KEIKI CO., LTD., Japan). The smaller the hardness of the foam at 22° C., the better the flexibility of the foam. On the other hand, the smaller the hardness of the foam at −10° C., the better the low temperature characteristics of the foam.

(3) Tensile Strength, Elongation and Tearing Strength

Using a dumbbell cutter No. 2, a sample was produced from a foam having a thickness of 3 mm. With respect to the sample, the measurement was performed in accordance with ASTM-D412.

(4) Compression Set

The compression set of the foam was measured in accordance with ASTM-D3754 by the following method. A sample of the foam, which is in the shape of a column having a height (thickness) of 10 mm and a diameter of 30 mm, is placed in a compressor. The sample is compressed so that the resultant, compressed sample has a thickness which is lowered by 50%, relative to the thickness of the sample prior to the compression (wherein there is used a space bar having a thickness which is half the thickness of the sample prior to the compression). The sample is kept compressed in the compressor at 50° C. for 6 hours. Then, the sample is taken out from the compressor and allowed to stand at room temperature. The compression set of the foam is defined by the following formula:
Cs(%)={(TO−TF)/(TO−TS)}×100
wherein TO represents the thickness of the sample prior to the compression, TF represents the thickness of the sample after the sample is allowed to stand at room temperature, and TS represents the thickness of the space bar.

The smaller the Cs value (compression set) of the foam, the better the compression set resistance of the foam.

(5) Impact Resilience

The impact resilience of the polymer foam was measured by the following method. A sample of the polymer foam, having a thickness of from 15 to 17 mm, is placed on a plate having a flat surface. At 22° C., a steel ball having a weight of 16.3 g is allowed to fall from the fall height above the sample to cause the ball to collide against the sample. The fall height of the ball and the resilience height of the ball after the collision of the ball against the sample are measured. The impact resilience of the polymer foam is defined by the following formula:
Impact resilience(%)=(HR/HO)×100,
wherein HO represents the fall height of the ball, and HR represents the resilience height of the ball after the collision of the ball against the sample.

The smaller the impact resilience of the polymer foam, the better the shock-absorbing property of the polymer foam.

C. Preparation of Hydrogenation Catalysts

Hydrogenation catalysts I and II used in hydrogenation reactions were prepared by the following methods.

(1) Hydrogenation Catalyst I

A reaction vessel was purged with nitrogen. To the reaction vessel was fed one liter of dried, purified cyclohexane, followed by addition of 100 mmol of bis(η⁵-cyclopentadienyl)titanium dichloride. While thoroughly stirring the resultant mixture in the reaction vessel, an n-hexane solution containing 200 mmol of trimethylaluminum was fed to the reaction vessel, and a reaction was performed at room temperature for about 3 days to thereby obtain hydrogenation catalyst I (which contained titanium).

(2) Hydrogenation Catalyst II

A reaction vessel was purged with nitrogen. To the reaction vessel was fed two liters of dried, purified cyclohexane, followed by addition of 40 mmol of bis(η⁵-cyclopentadienyl)titanium di(p-tolyl) and 150 g of 1,2-polybutadiene having a molecular weight of about 1,000 and a 1,2-vinyl bond content of about 85%. To the resultant solution was added a cyclohexane solution containing 60 mmol of n-butyllithium, and a reaction was performed at room temperature for 5 minutes. To the resultant reaction mixture was immediately added 40 mmol of n-butanol, followed by stirring, thereby obtaining hydrogenation catalyst II.

D. Preparation of Hydrogenated Copolymers or the Like

<Polymer 1>

Using a reaction vessel which had an internal volume of 10 liters and was equipped with a stirrer and a jacket, a copolymerization was performed by the following method.

Parts by weight of cyclohexane was fed to the reaction vessel, and the temperature in the reaction vessel was adjusted to 70° C. Then, n-butyllithium and N,N,N′,N′-tetramethylethylenediamine (hereinafter referred to as “TMEDA”) were fed to the reaction vessel, wherein the amount of the n-butyllithium was 0.08% by weight, based on the total weight of the monomers (i.e., the total weight of butadiene and styrene, fed to the reaction vessel), and the amount of the TMEDA was 0.4 mol per mol of the n-butyllithium.

A cyclohexane solution containing 8 parts by weight of styrene (styrene concentration of the solution: 22% by weight) was fed to the reaction vessel over 3 minutes, and a polymerization reaction (first polymerization reaction) was performed for 30 minutes while maintaining the internal temperature of the reaction vessel at about 70° C.

Then, a cyclohexane solution containing 48 parts by weight of butadiene and 36 parts by weight of styrene (total concentration of butadiene and styrene of the solution: 22% by weight) was continuously fed to the reaction vessel at a constant rate over 60 minutes to thereby perform a polymerization reaction (second polymerization reaction). During the polymerization reaction, the internal temperature of the reaction vessel was maintained at about 70° C.

Thereafter, a cyclohexane solution containing 8 parts by weight of styrene (styrene concentration of the solution: 22% by weight) was fed to the reaction vessel over 3 minutes, and a polymerization reaction (third polymerization reaction) was performed for 30 minutes while maintaining the internal temperature of the reaction vessel to about 70° C., thereby obtaining an unhydrogenated copolymer.

The obtained unhydrogenated copolymer had a styrene monomer unit content of 52% by weight, a styrene polymer block content of 16% by weight, and a vinyl bond content of 20% by weight as measured with respect to the butadiene monomer units in the unhydrogenated copolymer. Further, the unhydrogenated copolymer had a weight average molecular weight of 150,000 and a molecular weight distribution of 1.1.

To the unhydrogenated copolymer was added the above-mentioned hydrogenation catalyst II in an amount of 100 ppm by weight, in terms of the amount of titanium, based on the weight of the unhydrogenated copolymer, and a hydrogenation reaction was performed under conditions wherein the hydrogen pressure was 0.7 MPa and the reaction temperature was 65° C. After completion of the hydrogenation reaction, methanol was added to the reaction vessel in an amount of 0.1% by weight, based on the weight of the unhydrogenated copolymer, followed by addition of, as a stabilizer, octadecyl-3-(3,5-di-t-butyl-4-hydroxyphenyl)propionate in an amount of 0.3% by weight, based on the weight of the unhydrogenated copolymer, to thereby obtain a hydrogenated copolymer (hereinafter, this copolymer is referred to as “polymer 1”).

Polymer 1 had a hydrogenation ratio of 99%. Further, in a dynamic viscoelastic spectrum obtained with respect to polymer 1, a peak of tanb was observed at −15° C. Moreover, in a DSC chart obtained with respect to polymer 1, substantially no crystallization peak ascribed to a styrene/butadiene copolymer block was observed at −50 to 100° C.

<Polymer 2>

An unhydrogenated copolymer was obtained in substantially the same manner as in the production of polymer 1, except that the amounts of n-butyllithium and monomers (i.e., butadiene and styrene) fed to the reaction vessel were changed as follows: the amount of n-butyllithium fed to the reaction vessel was 0.07% by weight; the amount of styrene fed to the reaction vessel for the first polymerization reaction was 6 parts by weight; the amounts of butadiene and styrene, fed to the reaction vessel for the second polymerization reaction, were 54 parts by weight and 34 parts by weight, respectively; and the amount of styrene fed to the reaction vessel for the third polymerization reaction was 6 parts by weight.

The obtained unhydrogenated copolymer had a styrene monomer unit content of 46% by weight, a styrene polymer block content of 12% by weight, and a vinyl bond content of 22% by weight as measured with respect to the butadiene monomer units in the unhydrogenated copolymer. Further, the unhydrogenated copolymer had a weight average molecular weight of 165,000 and a molecular weight distribution of 1.1.

A hydrogenation reaction was performed in substantially the same manner as in the production of polymer 1, thereby obtaining a hydrogenated copolymer (hereinafter, this copolymer is referred to as “polymer 2”).

Polymer 2 had a hydrogenation ratio of 98%. Further, in a dynamic viscoelastic spectrum obtained with respect to polymer 2, a peak of tanδ was observed at −25° C. Moreover, in a DSC chart obtained with respect to polymer 2, substantially no crystallization peak ascribed to a styrene/butadiene copolymer block was observed at −50 to 100° C.

<Polymer 3>

A living polymer was obtained in the form of a solution thereof in substantially the same manner as in the case of polymer 1. To the solution of the living polymer was added 1,3-dimethyl-2-imidazblidinone as a modifier in an amount equimolar to the n-butyllithium used for the production of the living polymer, thereby obtaining a modified, unhydrogenated copolymer. The modified, unhydrogenated copolymer had a modification ratio of 70%.

Then, to the modified, unhydrogenated copolymer in the form of a solution thereof was added hydrogenation catalyst II in an amount of 100 ppm by weight, in terms of the amount of titanium, based on the weight of the modified, unhydrogenated copolymer, and a hydrogenation reaction was performed under conditions wherein the hydrogen pressure was 0.7 MPa and the reaction temperature was 70° C. After completion of the hydrogenation reaction, octadecyl-3-(3,5-di-t-butyl-4-hydroxyphenyl)propionate as a stabilizer was added to the reaction vessel in an amount of 0.3 part by weight, relative to 100 parts by weight of the modified, unhydrogenated copolymer, followed by removal of the solvent, to thereby obtain a modified, hydrogenated copolymer (hereinafter, this copolymer is referred to as “polymer 3”).

Polymer 3 had a hydrogenation ratio of 99%. Further, in a dynamic viscoelastic spectrum obtained with respect to polymer 3, a peak of tans was observed at −15° C. Moreover, in a DSC chart obtained with respect to polymer 3, substantially no crystallization peak ascribed to a styrene/butadiene copolymer block was observed at −50 to 100° C.

<Polymer 4>

To polymer 3 was added maleic anhydride in an amount of 2.1 mol, relative to one equivalent of the functional group bonded to polymer 3. The resultant mixture was melt-kneaded for about 2 minutes by means of a 30 mmΦ twin-screw extruder under conditions wherein the temperature was 210° C. and the screw revolution rate was 100 rpm, thereby obtaining a second-order modified, hydrogenated copolymer (hereinafter, this copolymer is referred to as “polymer 4”).

In a dynamic viscoelastic spectrum obtained with respect to polymer 4, a peak of tanδ was observed at −15° C. Further, in a DSC chart obtained with respect to polymer 4, substantially no crystallization peak ascribed to a styrene/butadiene copolymer block was observed at −50 to 100° C.

<Rubbery Polymer 1>

An unhydrogenated copolymer was produced by performing a continuous polymerization by the following method in which there were used two reaction vessels (i.e., a first reaction vessel and a second reaction vessel), each of which had an internal volume of 10 liters and was equipped with a stirrer and a jacket.

A cyclohexane solution of butadiene (butadiene concentration of the solution: 24% by weight), a cyclohexane solution of styrene (styrene concentration of the solution: 24% by weight), and a cyclohexane solution of n-butyllithium (which contained 0.077 part by weight of n-butyllithium, relative to 100 parts by weight of the total of the butadiene and the styrene) were fed to the bottom portion of the first reaction vessel at feeding rates of 4.51 liters/hr, 5.97 liters/hr and 2.0 liters/hr, respectively, while feeding a cyclohexane solution of TMEDA to the first reaction vessel at a feeding rate such that the amount of the TMEDA was 0.44 mol per mol of the n-butyllithium, thereby performing a continuous polymerization at 90° C. to obtain a polymerization reaction mixture. In the continuous polymerization, the reaction temperature was adjusted by controlling the jacket temperature. The temperature around the bottom portion of the first reaction vessel was about 88° C. and the temperature around the top of the first reaction vessel was about 90° C. The average residence time of the polymerization reaction mixture in the first reaction vessel was about 45 minutes. The conversions of butadiene and styrene were approximately 100% and 99%, respectively.

From the first reaction vessel, a polymer solution was withdrawn, and fed to the bottom portion of the second reaction vessel. Simultaneously with the feeding of the polymer solution, a cyclohexane solution of styrene (styrene concentration of the solution: 24% by weight) was fed to the bottom portion of the second reaction vessel at a feeding rate of 2.38 liters/hr, thereby performing a continuous polymerization at 90° C. to obtain an unhydrogenated copolymer. The conversion of styrene as measured at the outlet of the second reaction vessel was 98%.

The obtained unhydrogenated copolymer was analyzed by the above-mentioned methods. As a result, it was found that the unhydrogenated copolymer had a styrene monomer unit content of 67% by weight, a styrene polymer block content of 20% by weight, and a vinyl bond content of 14% by weight as measured with respect to the butadiene monomer units in the unhydrogenated copolymer. It was also found that the unhydrogenated copolymer had a weight average molecular weight of 200,000 and a molecular weight distribution of 1.9.

Then, to the unhydrogenated copolymer was added the above-mentioned hydrogenation catalyst I in an amount of 100 ppm by weight, in terms of the amount of titanium, based on the weight of the unhydrogenated copolymer, and a hydrogenation reaction was performed under conditions wherein the hydrogen pressure was 0.7 MPa and the reaction temperature was 65° C. After completion of the hydrogenation reaction, methanol was added to the second reaction vessel, followed by addition of, as a stabilizer, octadecyl-3-(3,5-di-t-butyl-4-hydroxyphenyl)propionate in an amount of 0.3 part by weight, relative to 100 parts by weight of the unhydrogenated copolymer, to thereby obtain a hydrogenated copolymer (hereinafter, this copolymer is referred to as “rubbery polymer 1”).

Rubbery polymer 1 had a hydrogenation ratio of 99%. Further, in a dynamic viscoelastic spectrum obtained with respect to rubbery polymer 1, a peak of tanδ was observed at 10° C. Moreover, in a DSC chart obtained with respect to rubbery polymer 1, substantially no crystallization peak ascribed to a styrene/butadiene copolymer block was observed at −50 to 100° C.

### EXAMPLE 1

70 Parts by weight of polymer 1 as a hydrogenated copolymer, 30 parts by weight of rubbery polymer 1 as a rubbery polymer, and additives as indicated, together with the amounts thereof, in the item “first step” of Table 1, were fed to a kneader (melt-kneading machine) (trade name: DJ K-1; manufactured and sold by Dae-Jung Precision Machinery Co., Korea). The resultant mixture was melt-kneaded at about 120° C. for 15 minutes, thereby obtaining a kneaded mixture (hereinafter, this kneaded mixture is referred to as “first kneaded mixture”). Then, the first kneaded mixture and additives as indicated, together with the amounts thereof, in the item “second step” of Table 1, were fed to a two-roll open mill (melt-kneading machine) (trade name: DJ M; manufactured and sold by Dae-Jung Precision Machinery Co., Korea), and the resultant mixture was melt-kneaded at about 100° C. for 10 minutes, thereby obtaining a kneaded mixture (hereinafter, this kneaded mixture is referred to as “second kneaded mixture”).

The second kneaded mixture was subjected to a compression molding at 160° C. under 150 kgf/cm² for 20 minutes using a compression molding machine (trade name: DJ PT; manufactured and sold by Dae-Jung Precision Machinery Co., Korea). 20 Minutes after completion of the compression molding, the resultant compressed mixture was cooled to room temperature while maintaining the pressure in the compression molding machine at 150 kgf/cm². Thereafter, the pressure in the compression molding machine was relieved to effect foaming of the compressed mixture, thereby obtaining a polymer foam.

The properties of the obtained polymer foam are shown in Table 1. As seen from Table 1, the polymer foam had excellent properties with respect to flexibility, low temperature characteristics, compression set resistance and shock-absorbing property (low impact resilience).

### EXAMPLE 2

A polymer foam was obtained in substantially the same manner as in Example 1, except that polymers and additives as indicated, together with the amounts thereof, in Table 1 were used.

The properties of the obtained polymer foam are shown in Table 1. As seen from Table 1, the polymer foam had excellent properties with respect to flexibility, low temperature characteristics, compression set resistance and shock-absorbing property (low impact resilience).

### EXAMPLE 3

A polymer foam was obtained in substantially the same manner as in Example 1, except that polymers and additives as indicated, together with the amounts thereof, in Table 1 were used.

The properties of the obtained polymer foam are shown in Table 1. As seen from Table 1, the polymer foam had excellent properties with respect to flexibility, low temperature characteristics, compression set resistance and shock-absorbing property (low impact resilience).

### EXAMPLE 4

A polymer foam was obtained in substantially the same manner as in Example 1, except that polymers and additives as indicated, together with the amounts thereof, in Table 1 were used.

The properties of the obtained polymer foam are shown in Table 1. As seen from Table 1, the polymer foam had excellent properties with respect to flexibility, low temperature characteristics, compression set resistance and shock-absorbing property (low impact resilience).

### EXAMPLE 5

A polymer foam was obtained in substantially the same manner as in Example 1, except that polymers and additives as indicated, together with the amounts thereof, in Table 1 were used.

The properties of the obtained polymer foam are shown in Table 1. As seen from Table 1, the polymer foam had excellent properties with respect to flexibility, low temperature characteristics, compression set resistance and shock-absorbing property (low impact resilience).

### EXAMPLE 6

A polymer foam was obtained in substantially the same manner as in Example 1, except that the following changes were made: as a hydrogenated copolymer, 35 parts by weight of polymer 1 was used; as an olefin polymer, 30 parts by weight of an ethylene/vinyl acetate copolymer (trade name: EVA460; manufactured and sold by DuPont de Nemours & Company Inc., U.S.A.; vinyl acetate monomer unit content: 18% by weight) was used; and as a rubbery polymer, 35 parts by weight of a hydrogenation product of a styrene/isoprene block copolymer (trade name: Hybrar 7125; manufactured and sold by KURARAY CO., LTD., Japan) was used.

The obtained polymer foam had a specific gravity of 0.18. Further, the polymer foam had excellent properties as comparable to those of the polymer foam obtained in Example 1.

### EXAMPLE 7

A polymer foam was obtained in substantially the same manner as in Example 1, except that, instead of polymer 1, polymer 3 was used as a hydrogenated copolymer.

The obtained polymer foam had a specific gravity of 0.22. Further, the polymer foam had excellent properties as comparable to those of the polymer foam obtained in Example 1.

### EXAMPLE 8

A polymer foam was obtained in substantially the same manner as in Example 1, except that, instead of polymer 1, polymer 4 was used as a hydrogenated copolymer.

The obtained polymer foam had a specific gravity of 0.23. Further, the polymer foam had excellent properties as comparable to those of the polymer foam obtained in Example 1.

### COMPARATIVE EXAMPLE 1

A polymer foam was obtained in substantially the same manner as in Example 1, except that a polymer and additives as indicated, together with the amounts thereof, in Table 1 were used.

The properties of the obtained polymer foam are shown in Table 1. As seen from Table 1, the polymer foam was poor with respect to low temperature characteristics (flexibility at a low temperature of −10° C.).

TABLE 1

| | Formulation | | Type of polymer | Ex. 1 | Ex. 2 | Ex. 3 | Ex. 4 | Ex. 5 | Comp. Ex. 1 |
|---|---|---|---|---|---|---|---|---|---|
| First step | Component | Hydrogenated | Polymer 1 | 70 | 50 | — | 50 | 50 | — |
| | (A) | copolymer | Polymer 2 | — | — | 40 | — | — | — |
| | Component | Olefin polymer | Ethylene/butene | — | — | — | 20 | — | — |
| | (B) | | copolymer (*1) | | | | | | |
| | | Rubbery polymer | Rubbery polymer 1 | 30 | 50 | 60 | 30 | 30 | 100 |
| | | | SIS (*2) | — | — | — | — | 20 | — |

| | Additives | Zinc oxide | 5 | 5 | 5 | 5 | 5 | 5 |
|---|---|---|---|---|---|---|---|---|
| | | Stearic acid | 1 | 1 | 1 | 1 | 1 | 1 |
| | | Titanium oxide | 4 | 4 | 4 | 4 | 4 | 4 |
| | | Zinc stearate | 1 | 1 | 1 | 1 | 1 | 1 |
| Second step | Additives | Peroxide (*3) | 2.0 | 2.0 | 2.1 | 1.8 | 1.7 | 2.0 |
| | | Auxiliary crosslinkng agent (*4) | 0.4 | 0.4 | 0.4 | 0.4 | 0.4 | 0.4 |
| | | Foaming agent (*5) | 4.0 | 4.0 | 4.0 | 4.0 | 3.5 | 4.0 |

| Properties | Specific gravity | | 0.23 | 0.23 | 0.19 | 0.20 | 0.21 | 0.22 |
|---|---|---|---|---|---|---|---|---|
| | Hardness | 22° C. | 40 | 41 | 39 | 45 | 37 | 43 |
| | | −10° C. | 50 | 56 | 49 | 54 | 47 | 69 |

| | | | | | | |
|---|---|---|---|---|---|---|
| Tensile strength (kgf/cm²) | 24 | 26 | 22 | 28 | 21 | 22 |
| Elongation (%) | 250 | 280 | 260 | 250 | 260 | 260 |
| Stearing strength (kgf/cm) | 6.6 | 7.1 | 6.4 | 8.0 | 5.3 | 4.8 |
| Compression set (%) | 44 | 43 | 50 | 46 | 52 | 40 |
| Impact resilience (%) | 29 | 19 | 30 | 31 | 34 | 9 |

Notes
(*1) Ethylene/butene copolymer (trade name: Tafmer DF 110; manufactured and sold by Mitsui Chemicals Inc., Japan)
(*2) Styrene/isoprene block copolymer (trade name: KTR 802; St content: 15 wt %; manufactured and sold by Kumho Petrochem Co., Korea)
(*3) Dicumyl peroxide (manufactured and sold by Akzo nobel, Holland)
(*4) Triallyl cyanurate (manufactured and sold by Akzo nobel, Holland)
(*5) Azodicarbonamide (manufactured and sold by Kum-Yang Co., Ltd., Korea)

### INDUSTRIAL APPLICABILITY

The polymer foam of the present invention has excellent properties with respect to flexibility, low temperature characteristics (such as flexibility at low temperatures), shock-absorbing property (low impact resilience), compression set resistance and the like, so that the polymer foam can be advantageously used as shock absorbers (especially footwear materials, such as materials for insoles and midsoles), materials for household electric appliances (shock absorbers or cushioning materials for rotating machines, and the like), materials for automobile parts (vibration cushioning materials, vibration damping, soundproofing materials, and the like), cushioning materials for packaged goods, and the like.

1. A polymer foam comprising a plurality of cells defined by cell walls which constitute a polymer matrix,
said polymer matrix being comprised of:
5 to 100 parts by weight, relative to 100 parts by weight of the total of components (A) and (B), of (A) a hydrogenated copolymer obtained by hydrogenating an unhydrogenated copolymer comprising vinyl aromatic monomer units and conjugated diene monomer units, said unhydrogenated copolymer containing at least one copolymer block S comprised of vinyl aromatic monomer units and conjugated diene monomer units, and
95 to 0 part by weight, relative to 100 parts by weight of the total of components (A) and (B), of (B) at least one polymer selected from the group consisting of an olefin polymer other than said hydrogenated copolymer (A) and a rubbery polymer other than said hydrogenated copolymer (A),
said hydrogenated copolymer (A) having the following characteristics (1) and (2):
(1) said hydrogenated copolymer (A) has a content of said vinyl aromatic monomer units of from more than 40% by weight to 60% by weight, based on the weight of said hydrogenated copolymer (A), and
(2) at least one peak of loss tangent (tanδ) is observed at −40° C. to lower than −10° C. in a dynamic viscoelastic spectrum obtained with respect to said hydrogenated copolymer (A),
said polymer foam having a specific gravity of from 0.05 to 0.5.

2. The polymer foam according to claim 1, wherein the amounts of said hydrogenated copolymer (A) and said polymer (B) are, respectively, 5 to 95 parts by weight and 95 to 5 parts by weight, relative to 100 parts by weight of the total of components (A) and (B).

3. The polymer foam according to claim 1 or 2, wherein substantially no crystallization peak ascribed to at least one hydrogenated copolymer block obtained by hydrogenating said at least one copolymer block S is observed at −50 to 100° C. in a differential scanning calorimetry (DSC) chart obtained with respect to said hydrogenated copolymer (A).

4. The polymer foam according to claim 1 or 2, wherein at least one of said at least one copolymer block S in said unhydrogenated copolymer has a structure wherein said vinyl aromatic monomer units are distributed in a tapered configuration.

5. The polymer foam according to claim 1 or 2, wherein said unhydrogenated copolymer further contains a homopolymer block H of vinyl aromatic monomer units, the amount of said homopolymer block H in said unhydrogenated copolymer being in the range of from 1 to 40% by weight, based on the weight of said unhydrogenated copolymer.

6. The polymer foam according to claim 1 or 2, wherein said unhydrogenated copolymer is at least one polymer selected from the group consisting of copolymers which are, respectively, represented by the following formulae:
S, (1)
S—H, (2)
S—H—S, (3)
(S—H)ₘ—X, (4)
(S—H)ₙ—X—(H)ₚ, (5)
H—S—H, (6)
S-E, (7)
H—S-E, (8)
E-S—H—S, (9)
(E-S—H)ₘ—X and (10)
(E-S-E)ₘ—X, (11)
wherein each S independently represents a copolymer block comprised of vinyl aromatic monomer units and conjugated diene monomer units, each H independently represents a homopolymer block of vinyl aromatic monomer units, each E independently represents a homopolymer block of conjugated diene monomer units, each X independently represents a residue of a coupling agent, each m independently represents an integer of 2 or more, and each of n and p independently represents an integer of 1 or more.

7. The polymer foam according to claim 1 or 2, wherein said hydrogenated copolymer (A) has bonded thereto a modifier having a functional group.

8. The polymer foam according to claim 7, wherein said modifier is a first-order modifier having at least one functional group selected from the group consisting of a hydroxyl group, an epoxy group, an amino group, a silanol group and an alkoxysilane group.

9. The polymer foam according to claim 7, wherein said modifier comprises a first-order modifier and, bonded thereto, a second-order modifier,
wherein said first-order modifier has at least one functional group selected from the group consisting of a hydroxyl group, an epoxy group, an amino group, a silanol group and an alkoxysilane group, and
wherein said second-order modifier has at least one functional group selected from the group consisting of a hydroxyl group, a carboxyl group, an acid anhydride group, an isocyanate group, an epoxy group and an alkoxysilane group.

10. The polymer foam according to claim 1 or 2, wherein said olefin polymer as component (B) is at least one ethylene polymer selected from the group consisting of a polyethylene, an ethylene/propylene copolymer, an ethylene/propylene/butylene copolymer, an ethylene/butylene copolymer, an ethylene/hexene copolymer, an ethylene/octene copolymer, an ethylene/vinyl acetate copolymer, an ethylene/acrylic ester copolymer and an ethylene/methacrylic ester copolymer.

11. The polymer foam according to claim 1 or 2, wherein said rubbery polymer as component (B) is at least one member selected from the group consisting of a 1,2-polybutadiene, a hydrogenation product of a conjugated diene homopolymer, a copolymer comprised of vinyl aromatic monomer units and conjugated diene monomer units and a hydrogenation product thereof, a block copolymer comprised of a homopolymer block of vinyl aromatic monomer units and at least one polymer block selected from the group consisting of a homopolymer block of conjugated diene monomer units and a copolymer block comprised of vinyl aromatic monomer units and conjugated diene monomer units and a hydrogenation product thereof, an acrylonitrile/butadiene rubber and a hydrogenation product thereof, an ethylene/propylene/diene rubber (EPDM), a butyl rubber and a natural rubber.

12. The polymer foam according to claim 11, wherein said rubbery polymer as component (B) is at least one member selected from the group consisting of a hydrogenation product of a copolymer comprised of vinyl aromatic monomer units and conjugated diene monomer units, said hydrogenation product having a vinyl aromatic monomer unit content of from more than 60% by weight to 90% by weight, based on the weight of said hydrogenation product; and a block copolymer comprised of a homopolymer block of vinyl aromatic monomer units and at least one polymer block selected from the group consisting of a homopolymer block of conjugated diene monomer units and a copolymer block comprised of vinyl aromatic monomer units and conjugated diene monomer units and a hydrogenation product thereof.

13. The polymer foam according to claim 1 or 2, which exhibits an impact resilience of 40% or less.

14. The polymer foam according to claim 1 or 2, which has a specific gravity of from 0.1 to 0.3.

15. The polymer foam according to claim 1 or 2, which is a shock absorber.
